(19) United States
(12) Patent Application Publication
(10) Pub. No.: US 2026/0129447 A1
(43) Pub. Date: May 7, 2026

(54) ESTABLISHING SECURITY IN A COMMON APPLICATION PROGRAMMING INTERFACE FRAMEWORK

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 18/935,195

(22) Filed: Nov. 1, 2024

(51) Int. Cl. H04W 12/069; H04W 12/0431; H04W 12/086

(52) U.S. Cl. CPC H04W 12/069; H04W 12/0431; H04W 12/086

(57) ABSTRACT

Various aspects of the present disclosure relate to establishing security in a common application programming interface framework. An apparatus for wireless communication implements a first common application programming interface (API) framework (CAPIF) core function (CCF). The apparatus receives a first signaling indicating a first authentication request corresponding to an API invoker, the first authentication request including one or more of an API invoker identifier (ID) of the API invoker, an API exposing function (AEF) information, or service API information. The apparatus transmits, to a second CCF, a second signaling indicating a second authentication request, wherein the second authentication request includes one or more of the API invoker ID, an API invoker uniform resource indicator (URI), the indication of the AEF, the service API information, a pre-shared key for the AEF, or a root certifying authority (CA) for a certificate of the API invoker.

### TECHNICAL FIELD

The present disclosure relates to wireless communications, and more specifically to establishing security in a common application programming interface (API) framework (CAPIF).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include an apparatus for wireless communication. The apparatus implements a first CAPIF core function (CCF) and receives a first signaling indicating a first authentication request corresponding to an API invoker, where the first authentication request includes one or more of an API invoker identifier (ID) of the API invoker, an API invoker uniform resource indicator (URI), an API exposing function (AEF) information, or service API information; and transmits, to a second CCF, a second signaling indicating a second authentication request, where the second authentication request includes one or more of the API invoker ID, the API invoker URI, the AEF information, the service API information, a pre-shared key for the AEF, or a root certificate of a certifying authority (CA) to validate a certificate of the API invoker.

In some implementations of the method and apparatuses described herein, the second authentication request includes an identifier of the first CCF, and the apparatus receives the first signaling from the API invoker. Additionally, or alternatively, the first CCF and the second CCF are located in two different trust domains or in a same trust domain. Additionally, or alternatively, the apparatus transmits the second signaling to the second CCF based at least in part on the AEF information or the service API information. Additionally, or alternatively, the AEF information includes at least one of an identifier of the AEF or an identifier of the second CCF related to the AEF. Additionally, or alternatively, the apparatus derives, prior to receiving the first signaling and based at least in part on an identifier or address of the second CCF, the pre-shared key for the AEF. Additionally, or alternatively, the first authentication request includes an authentication data or security information forward request, where the second authentication request includes an additional authentication data or security information notify or store request, and where the apparatus receives, from the second CCF, a third signaling indicating a success or failure indication that indicates whether the first CCF is allowed to perform the additional authentication data or security information notify or store request for the AEF or service API; and transmits, to the API invoker, a fourth signaling indicating the success or failure indication.

Some implementations of the method and apparatuses described herein may further include an apparatus for wireless communication. The apparatus implements a first CCF and receives a first signaling indicating a security information request corresponding to an API invoker, where the security information request includes one or more of an API invoker ID of the API invoker, service API information, or AEF information; and transmits a second signaling indicating a response, where the response includes at least one of a pre-shared key for the AEF, or a root certificate of a CA to validate a certificate of the API invoker.

In some implementations of the method and apparatuses described herein, the apparatus to receive the first signaling from the AEF. Additionally, or alternatively, the first CCF and the second CCF are located in two different trust domains or in a same trust domain. Additionally, or alternatively, the AEF information includes at least one of service APIs supported by the AEF, an identifier of the AEF or an identifier of the second CCF. Additionally, or alternatively, the apparatus derives, prior to receiving the first signaling and based at least in part on an identifier or address of the second CCF, the pre-shared key for the AEF.

Some implementations of the method and apparatuses described herein may further include an apparatus for wireless communication. The apparatus implements a first CCF and receives a first signaling indicating an access token request corresponding to an API invoker, where the access request includes one or more of an API invoker ID of the API invoker, an AEF information, or service API information; and transmits a second signaling indicating an access token for the API invoker and one or more API services indicated in the service API information.

In some implementations of the method and apparatuses described herein, the apparatus receives a third signaling indicating an authentication data notify or store request, where the authentication data notify or store request includes one or more of the API invoker ID, information of a second CCF, security information related to a security method, or a root certificate of a CA of the API invoker; and transmits a fourth signaling indicating success or failure of the authentication request. Additionally, or alternatively, the access token request includes an identifier of a second CCF, where the access token indicates the first CCF is an issuer of the access token, and the apparatus to receive the first signaling from a second CCF and transmit the second signaling to the second CCF.

Some implementations of the method and apparatuses described herein may further include an apparatus for wireless communication. The apparatus that implements an API invoker and generates, based at least in part on a service API, AEF information related to a first CCF, or a security data sharing requirement of the AEF, CCF information for the first CCF; and transmits a first signaling indicating an authentication request corresponding to the API invoker, where the first signaling includes the CCF information for the first CCF.

In some implementations of the method and apparatuses described herein, the CCF information includes an ID or address of the first CCF. Additionally, or alternatively, the apparatus transmits the first signaling to the AEF. Additionally, or alternatively, the API invoker is onboarded to the first CCF. Additionally, or alternatively, the apparatus determines to include the CCF information in the authentication request in response to AEF being provided by a second CCF.

### BRIEF DESCRIPTION OF THE DRAWINGS

FIG. 1 illustrates an example of a wireless communications system in accordance with aspects of the present disclosure.

FIGS. 2 through 4 illustrates examples of interconnected CCF network diagrams in accordance with aspects of the present disclosure.

FIGS. 5 and 6 illustrate example procedures for API authentication.

FIGS. 7A through 13B illustrate examples of authentication and protection in a CAPIF interconnection scenario in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of a network equipment (NE) in accordance with aspects of the present disclosure.

FIGS. 17 through 20 illustrate flowcharts of methods in accordance with aspects of the present disclosure.

### DETAILED DESCRIPTION

API invokers (residing as part of an Application Function (AF), client, or UE) are onboarded to the CCF of a CAPIF provider and the API invokers access service APIs exposed by the AEF of the same CAPIF provider or CCF using a CAPIF-2/2e interface. In the case of a CAPIF interconnection scenario, there will be business relationship and service level agreements (SLAs) between different CCFs or CAPIF providers (e.g., referred to as A and B). In such cases, an API invoker will be onboarded to one CCF of CAPIF provider-A and access service APIs exposed by the AEFs of other CCFs of the same CAPIF provider-A or different CAPIF Provider-B using the CAPIF-2/2e interface.

In the case of CAPIF interconnection, following an API invoker successfully onboarding to the CCF (e.g., the designated CCF in a CAPIF provider domain, e.g., CCF-A), security method(s) to be used for CAPIF-2/2e reference point security between the API invoker and the AEFs belonging to CCF-A or CCF-B will be selected. Further the security information (e.g., a public client certificate of the API invoker, a root CA certificate to validate the client certificate, a secret key, a pre-shared secret key (e.g., transport layer security pre-shared secret key (TLS-PSK)), a CCF certificate or public key to validate the OAuth access token) is stored in the CCF (e.g., CCF-A) where the API invoker is onboarded. However, if the API invoker accesses service APIs exposed by the AEF of CCF-B, performing the CAPIF 2/2e related authentication and authorization for the API invoker service API invocation has various problems.

One such problems is if the AEF belongs to CCF-B, the AEF can access or request only its own CCF-B to fetch the security information to perform CAPIF-2/2e authentication and authorization. But the security information will be available only in CCF-A where the API invoker is onboarded, and the security information will not be available in the CCF-B of the AEF. Therefore, lack of timely security information at the CCF-B will lead to delay or service failure while the API invoker performs service API invocation towards the AEF of CCF-B.

Another such problem is that in a case of the interconnection scenario, an API invoker does not have the knowledge whether an AEF belongs to CCF-A or CCF-B, which leads to insufficient information being sent in the service API invocation request from the API invoker to the AEF of CCF-B, where it can impact security information fetching by AEF of CCF-B from or CCF-B or CCF-A (via CCF-B), respectively.

The techniques discussed herein resolve these problems in various manners. In one or more implementations, TLS-PSK based CAPIF 2/2e authentication and authorization is used with various aspects to enable security information/authentication and authorization data transfer (e.g., AEF pre-shared key (AEF_{PSK}), root certificate of CA to validate API invoker's certificate and optionally API invoker's client certificate) between the API invoker onboarded CCF (e.g., also referred to as source CCF or CCF-A) and a 3rd party CCF (e.g., also referred to as target CCF or CCF-B) that provides the service APIs via AEF to the API invoker. In one example, authentication initiation request and security information forwarding from the API invoker to the AEF via the CCF-A and the CCF-B is performed. In another example, API invoker or CCF-A triggered security information data transfer to CCF-B is performed to enable CAPIF 2/2e authentication and authorization between the API invoker and the AEF of CCF-B. In another example, the API invoker includes CCF-A information (e.g., onboarded CCF ID or address information) in an authentication initiation request based on the service APIs/AEF being provided by the CCF-B (e.g., as indicated during the API invoker onboarding or security method negotiation) and/or based on a security data sharing requirement indication per AEF received from the CCF-A to enable CAPIF 2/2c authentication and authorization between the API invoker and the AEF of CCF-B.

Additionally, or alternatively, TLS with OAuth token based CAPIF 2/2e authentication and authorization is used with various aspects to enable security information/authentication and authorization data transfer (e.g., root certificate of CA to validate API invoker's certificate and if optionally API invoker's client certificate from CCF A to CCF-B, OAuth access token from CCF-B to CCF-A) between the API invoker onboarded CCF and a 3rd party CCF that provides the service APIs via AEF to the API invoker. In one example, on receiving an OAuth access token request from the API invoker, the CCF-A requests the access token from the CCF-B by providing the API invoker ID, service API information and AEF details used for the issue of the OAuth access token by the CCF-B for the service API's provided by the CCF-B. In another example, during an OAuth access token request/response or following a successful OAuth access token response being sent to the API invoker, the CCF-A provides the CCF-B with the security information to enable CAPIF 2/2c authentication and authorization between the API invoker and the AEF of the CCF-B.

Aspects of the present disclosure are described in the context of a wireless communications system.

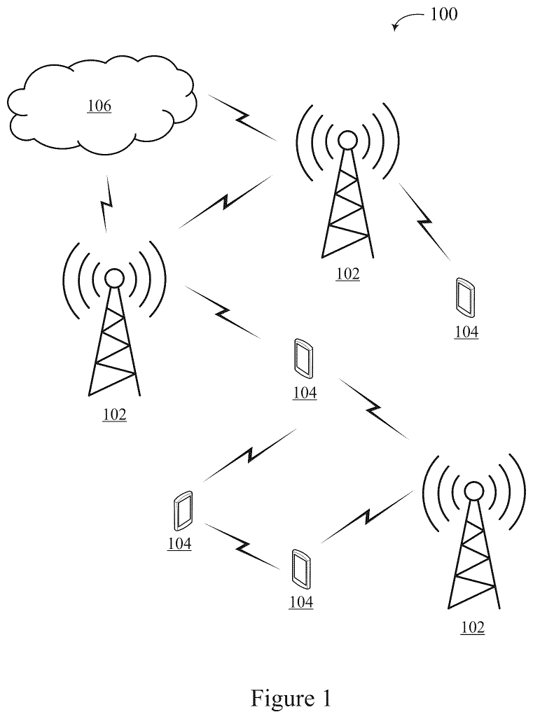

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Various one or more NE 102, one or more UE 104, and the CN 106 can include one or more API invokers, one or more CCFs, and one or more AEFs. An API invoker is onboarded to a CCF of a CAPIF provider and the API invoker can access service APIs exposed by the AEF of the onboarding CCF or CAPIF provider, or a CCF of a different CAPIF. Various authentication and/or authorization techniques are discussed herein that allow an API invoker to access an AEF in situations where the AEF is associated with a different CCF or CAPIF than the onboarding CCF of the API invoker.

A NE 102 and/or a UE 104 may implement a CCF, AEF, API invoker, or other functions and/or components for a common API framework (CAPIF), as described in further detail below, through various hardware and software configurations. For example, a NE 102 may implement a CCF using a combination of processors, memory, and network interfaces. The processors may execute software instructions stored in the memory to perform CAPIF functions, such as API exposure, policy management, and analytics. The network interfaces may enable communication with other network elements, AEFs, and API invokers. A NE 102 and/or a UE 104 may implement an AEF as software to handle exposure of APIs, process API requests, and interact with one or more CCFs for authentication and authorization. The AEF software may include interfaces to backend services and databases that the exposed APIs access. A UE 104 and/or a NE 102 may implement an API invoker through a software application or framework for discovering available APIs, handling authentication and authorization with CCFs, and making API calls to AEFs. The API invoker may store credentials, tokens, and other security information in secure storage at the UE 104 and/or the NE 102.

According to implementations, one or more of the NEs 102 and the UEs 104 are operable to implement various aspects of the techniques described with reference to the present disclosure. For example, a UE 104 and/or a NE 102 may implement one or more CCFs, including a first CCF and one or more other CCFs, including a second CCF. The first CCF may obtain API and/or AEF information for APIs and/or AEFs offered by other CCFs interconnected with the first CCF along with respective CCF addresses (e.g., IDs) for the APIs and/or AEFs. For example, if the first CCF is interconnected with a second CCF, then the first CCF may obtain API and/or AEF information with CCF addresses of the second CCF. An API invoker may send a request to the first CCF to access one or more APIs (e.g., via AEFs) of the first CCF or another CCF interconnected with the first CCF. The first CCF may verify that the API invoker is authorized to access the APIs and may transmit a response to the API invoker that includes respective CCF addresses of the requested APIs. The API invoker may store the respective CCF addresses of the requested APIs for future authentication and authorization between the API invoker and AEFs of the first CCF or the other CCFs.

In some examples, the first CCF may receive a request from an API invoker for one or more security methods for accessing one or more APIs via one or more AEFs. The security request may include respective CCF addresses for one or more AEFs. If the APIs are accessible via AEFs of the first CCF, then the first CCF may select the respective security methods for accessing the APIs. Additionally, or alternatively, if the APIs are accessible via AEFs of a second CCF, then the first CCF may transmit a request to the second CCF for the respective security methods for accessing the APIs. The second CCF may select the respective security methods for accessing the APIs and may transmit the respective security methods in a response to the first CCF. The first CCF may forward the respective security methods (e.g., for accessing the APIs via AEFs of the first CCF and for accessing the APIs via AEFs of the second CCF) to the API invoker. The API invoker may store the selected security methods, which may be for respective AEFs, along with designated CCF addresses.

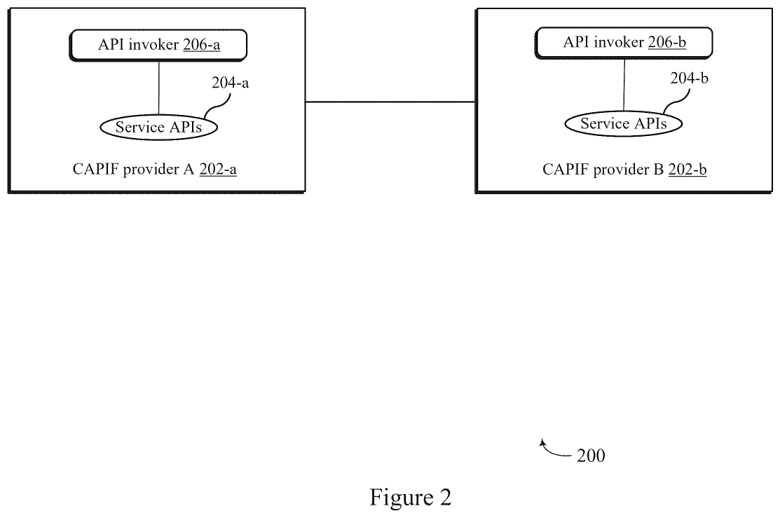

FIG. 2 illustrates an example interconnected CCF network diagram 200 in accordance with aspects of the present disclosure. Two CAPIF providers 202-a and 202-b are illustrated. The CAPIF provider 202-a may include or provide one or more service APIs 204-a, and the CAPIF provider 202-b may include or provide one or more service APIs 204-b. The service APIs 204-a and/or 204-b can be accessed by one or more API invokers 206-a and 206-b.

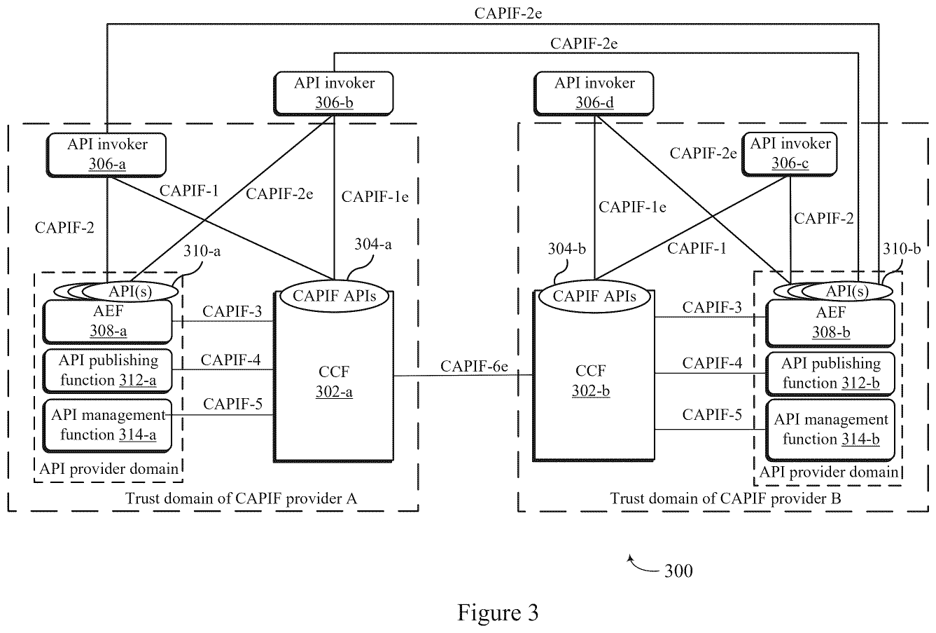

FIG. 3 illustrates an example interconnected CCF network diagram 300 in accordance with aspects of the present disclosure. In some examples, the interconnected CCF network diagram 300 implements or is implemented by aspects of the wireless communications system 100. For example, the interconnected CCF network diagram 300 may be implemented by one or more NEs and/or one or more UEs, which may be examples of the corresponding devices as described with reference to FIG. 1. The NEs and/or UEs may be examples of devices that implement one or more CCFs, API invokers, and AEFs, as described with reference to FIG. 1.

In some cases, a single device may implement a CCF 302-a and a CCF 302-b. In some other examples, a device may implement the CCF 302-a and a different device may implement the CCF 302-b. The CCF 302-a may be interconnected with the CCF 302-b via an interface, referred to as a CAPIF-6e interface. The CCF 302-a and the CCF 302-b may exchange control information and/or data via the CAPIF-6e interface. The CAPIF-6e interface may be an example of a wired or wireless connection. Example wired connections include, but are not limited to, ethernet connections, fiber optic links, or serial interfaces. For example, a NE implementing a CCF may use a fiber optic connection to communicate with other CN functions or data centers. Wireless interfaces may include over the air interfaces, such as cellular interfaces (e.g., NR), Wi-Fi, Bluetooth, or satellite communications. For example, a UE implementing an API invoker may use a transmitter or receiver to establish a wireless connection with a NE and communicate with CCFs and AEFs implemented by the NE. NEs may employ wireless backhaul links using over the air interfaces to connect remote sites to the CN.

The CCF 302-a may implement one or more CAPIF APIs 304-a, and a CCF 302-b may implement one or more CAPIF APIs 304-b. The CAPIF APIs 304-a and/or the CAPIF APIs 304-b may include a set of interfaces and functions provided by the CCF 302-a and the CCF 302-b, respectively, that enable interaction with and management of the CAPIF system. The CAPIF APIs 304-a and/or the CAPIF APIs 304-b may provide for other NEs, API invokers, and administrators to interact with the CCF 302-a and the CCF 302-b for API discovery, onboarding, security, and management, among other procedures. The CAPIF APIs 304-a and/or the CAPIF APIs 304-b may include interfaces for API invoker onboarding, which provides for new API consumers to register with the CCF 302-a and the CCF 302-b and obtain credentials. The CAPIF APIs 304-a and/or the CAPIF APIs 304-b may also provide functions for API discovery, enabling API invokers to search for and retrieve information about available APIs across interconnected CCFs.

For example, the CCF 302-a may establish a connection with one or more API invokers, such as the API invoker 306-a and the API invoker 306-b via the CAPIF API 304-a. The CCF 302-b may establish a connection with one or more API invokers, such as the API invoker 306-c and the API invoker 306-d. The connection between the CAPIF APIs 304-a and the API invoker 306-a, as well as the CAPIF APIs 304-b and the API invoker 306-c may be an example of a CAPIF-1 connection, which may be an example of a wired or wireless connection. The CAPIF-1 connection may be between CAPIF APIs and API invokers within a same trust domain of a CAPIF provider. For example, the CCF 302-a (e.g., and the CAPIF APIs 304-a) and the API invoker 306-a may be within the trust domain of a CAPIF provider A. The CCF 302-b (e.g., and the CAPIF APIs 304-b) and the API invoker 306-c may be within the trust domain of a CAPIF provider B. A trust domain of a CAPIF provider may refer to a logical boundary or grouping within which a set of CCFs, AEFs, and other network elements operate under a common set of security policies, authentication mechanisms, and access control rules. The trust domain may establish a framework of trust relationships between various components and entities within the CAPIF system.

The connection between the CAPIF APIs 304-a and the API invoker 306-b, as well as the CAPIF APIs 304-b and the API invoker 306-d may be an example of a CAPIF-1e connection, which may be an example or a wired or wireless connection. The CAPIF-1e connection may be between CAPIF APIs and API invokers that are outside of a trust domain of a CAPIF provider of the CAPIF APIs. For example, the API invoker 306-b may be outside of the trust domain of a CAPIF provider A of the CCF 302-a (e.g., and the CAPIF APIs 304-a). The API invoker 306-d may be outside of the trust domain of a CAPIF provider B of the CCF 302-b (e.g., and the CAPIF APIs 304-b). The CCF 302-a may establish a connection, such as a CAPIF-3 connection, with an AEF 308-a that exposes one or more APIs 310-a. The CCF 302-a may establish a connection, such as a CAPIF-4 connection, with an API publishing function 312-a. An API publishing function may refer to a component or service within an API provider that handles tasks related to registering, cataloging, and managing the lifecycle of APIs exposed by various AEFs. The API publishing function may ensure that published APIs align with CAPIF policies and security criterion. The CCF 302-a may establish a connection, such as a CAPIF-5 connection, with an API management function 314-a. An API management function may facilitate the creation, publication, maintenance, and monitoring of APIs. This function may provide capabilities for API design, testing, deployment, versioning, security, analytics, and developer support.

The CCF 302-b may establish a connection, such as a CAPIF-3 connection, with an AEF 308-b that exposes one or more APIs 310-b. The CCF 302-b may establish a connection, such as a CAPIF-4 connection, with an API publishing function 312-b. The CCF 302-b may establish a connection, such as a CAPIF-5 connection, with an API management function 314-b. The API invoker 306-a through the API invoker 306-d may establish a connection with the APIs 310-b and the APIs 310-a, such as a CAPIF-2 connection for API invokers within a trust domain of a CAPIF provider of the APIs or a CAPIF-2e connection for API invokers outside of the trust domain of the CAPIF provider of the APIs. A CAPIF-2 connection, a CAPIF-2e connection, a CAPIF-3 connection, a CAPIF-4 connection, and a CAPIF-5 connection may be examples of wired or wireless connections.

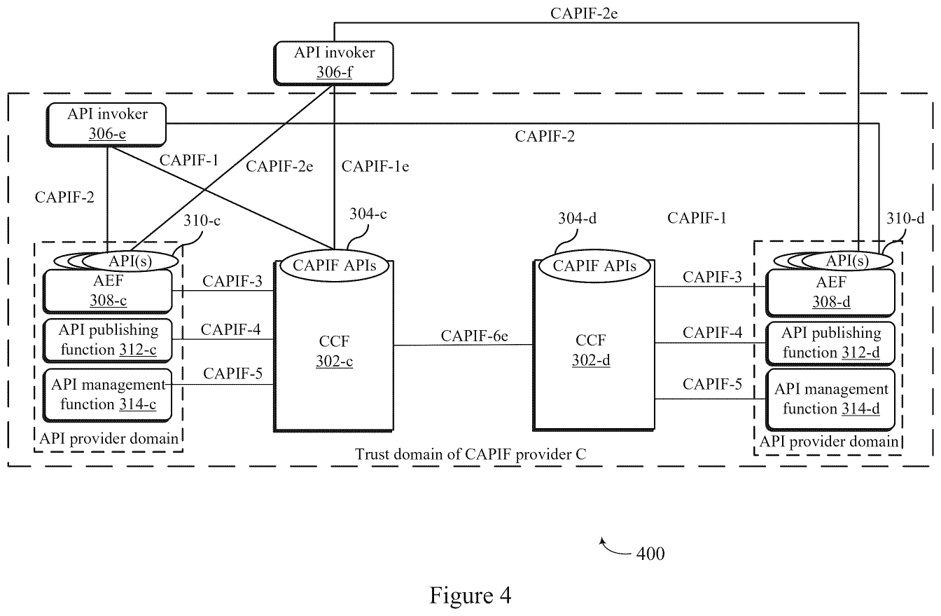

In some examples, the interconnection between the CCF 302-a and the CCF 302-b provides for API invokers of a CAPIF provider to utilize the APIs (e.g., service APIs) from third-party CAPIF providers, where the CAPIF providers belongs to different trust domains. Additionally, or alternatively, the interconnection between CCFs may be within a same CAPIF provider trust domain, which is described in further detail with respect to FIG. 4. The CCFs being within a same CAPIF provider trust domain provides for API invokers of a first CCF to utilize the APIs from a second CCF, where both the first CCF and the second CCF are hosted within the trust domain of the CAPIF provider.

In some examples, a CCF (e.g., one of the CCF 302-a and the CCF 302-b) may be a designated CCF, which is a CCF configured as a serving CCF for interconnection. Multiple organizations with a relationship that have deployed a CAPIF may interoperate to provide for API invokers in respective trust domains to utilize service APIs from both CAPIFs. The CAPIF provider A and the CAPIF provider B host the CAPIF in respective trust domains (e.g., a business relationship may exist between the CAPIF providers). The CAPIF providers in the respective trust domains may host multiple CAPIF instances, where each CAPIF instance includes a local CCF, the API provider domain, and the API invokers. When multiple CAPIF instances are deployed by a CAPIF provider there may be a hierarchy associated with the multiple CCFs deployed. A designated CCF of the CAPIF provider A (e.g., the CCF 302-a) may interconnect with a designated CCF of the CAPIF provider B (e.g., the CCF 302-b). Within CAPIF provider A, one or more CCFs interact with the designated CCF. The designated CCF of the CAPIF provider A provides information about the CAPIF instances and APIs deployed by the CAPIF provider A to the designated CCF of the CAPIF provider B (e.g., the CCF 302-b) and vice-versa via the CAPIF-6c connection.

The CCF 302-a of CAPIF provider A provides the information about the APIs to the CCF 302-b over CAPIF-6 reference point. The API invokers may exist within the trust domain of CAPIF provider A, within the trust domain of CAPIF provider B, or outside of the trust domains of both the CAPIF provider A and the CAPIF provider B. The API invoker of a CAPIF provider is onboarded with the CCF in the corresponding trust domain of the CAPIF provider. One or more CCFs can publish APIs to the designated CCF over the CAPIF-6 connection and discover the APIs from the designated CCF and vice versa over the CAPIF-6 connection. The API invoker within the trust domain of the CAPIF provider A interacts with the CCF of the CAPIF provider A via CAPIF-1 and discovers the APIs of both CAPIF providers and invokes the service APIs in the trust domain of CAPIF provider A via CAPIF-2 and invokes the service APIs in the trust domain of CAPIF provider B via CAPIF-2e. The API invoker from outside the trust domain of CAPIF providers, interacts with the CCF of the CAPIF provider A via CAPIF-1e and invokes the service APIs in the trust domain of the CAPIF providers via CAPIF-2c. In some cases, the communication between the CCF of the CAPIF providers over CAPIF-6 or CAPIF-6e can be API based.

FIG. 4 illustrates an example interconnected CCF network diagram 400 in accordance with aspects of the present disclosure. In some examples, the interconnected CCF network diagram 400 implements or is implemented by aspects of the wireless communications system 100 and the example interconnected CCF network diagram 400. For example, the interconnected CCF network diagram 400 may be implemented by one or more NEs and/or one or more UEs, which may be examples of the corresponding devices as described with reference to FIG. 1. The NEs and/or UEs may be examples of devices that implement one or more CCFs, API invokers, and AEFs, as described above.

In some examples, the example interconnected CCF network diagram 400 includes an API invoker 306-e within a trust domain of a CAPIF provider C and an API invoker 306-f outside of the trust domain of the CAPIF provider C. The example interconnected CCF network diagram 400 may also include a CCF 302-c with one or more CAPIF APIs 304-c and a CCF 302-d with one or more CAPIF APIs 304-d, which may be interconnected CCFs (e.g., via the CAPIF-6c connection). The CCF interconnection within the same CAPIF provider domain provides for API invokers of CCF 302-c (e.g., the API invoker 306-e and/or the API invoker 306-f) to utilize the APIs 310-d from a CCF 302-d, where both the CCF 302-c and the CCF 302-d are hosted within the trust domain of the CAPIF provider C. The CCF 302-c may be connected to the APIs 310-c, the AEF 308-c, the API publishing function 312-c, and the API management function 314-c (e.g., via a CAPIF-3 connection, a CAPIF-4 connection, and a CAPIF-5 connection). The CCF 302-d may be connected to the APIs 310-d, the AEF 308-d, the API publishing function 312-d, and the API management function 314-d (e.g., via a CAPIF-3 connection, a CAPIF-4 connection, and a CAPIF-5 connection). The API invoker 306-f may be connected to the APIs 310-c and the APIs 310-d via a CAPIF-2e connection. The API invoker 306-e may be connected to the APIs 310-c and the APIs 310-d via a CAPIF-2 connection.

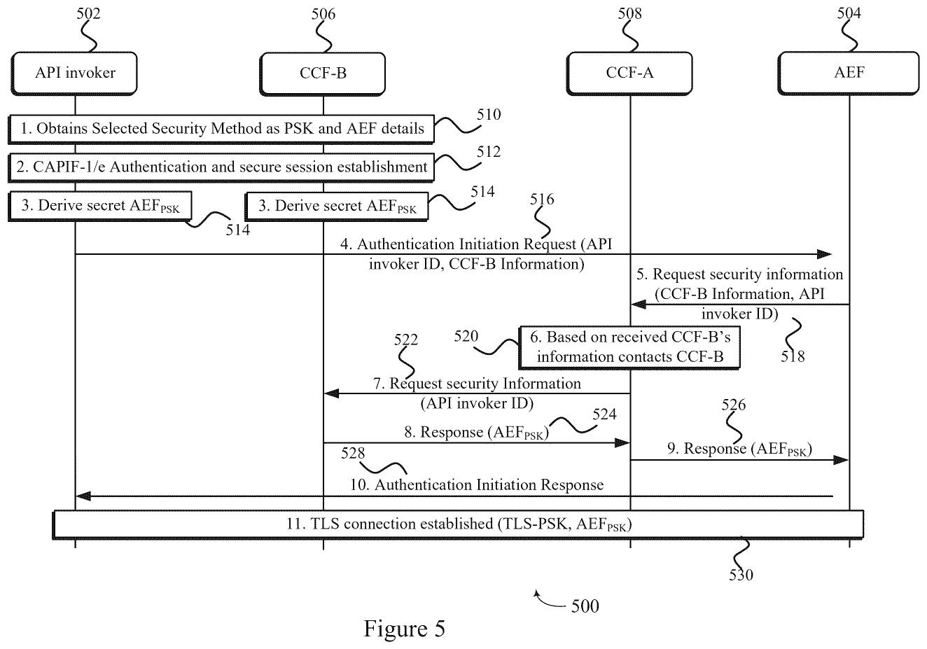

FIG. 5 illustrates an example procedure 500. The procedure 500 allows authenticating an API invoker 502 to an AEF 504 in a different security domain by requesting security information from another CCF in order to authenticate using TLS-PSK in CAPIF interconnect. In the procedure 500, CCF-B 506 and API invoker 502 have obtained a security method that allows authentication to the AEF 504, and any security information related to the security method TLS-PSK. Hence, the CCF-B 506 and the API invoker 502 can derive AEF_{PSK} based on the AEF's API service details.

The AEF 504 receives an Authentication Initiation Request from the API invoker 502, which includes the CCF-B 506 information where the API invoker 502 is registered. The AEF 504 requests security information of the API invoker 502 from the CCF-A 508 it is registered with, mentioning the API invoker ID and the CCF-B 506 information. The CCF-A 508 forwards the API invoker ID to the CCF-B 506 which responds to the CCF-A 508 with the AEF_{PSK}, which is forwarded to the AEF 504.

The API invoker 502 and the AEF 504 authenticate using AEF_{PSK} with the knowledge that the CCF-B 506 confirmed the API invoker ID information.

At 510 (step 1), the API invoker 502 gets the AEF 504 details using Obtains_Security method from the CCF-B 506. At 512 (step 2), mutual authentication based on client and server certificates is established using TLS between the API invoker 502 and the CCF-B 506. At 514 (step 3), the API invoker 502 and the CCF-B 506 derive AEF_{PSK} based on TLS master key used in step 2.

At 516 (step 4), the API invoker 502 sends an Authentication Initiation Request to the AEF 504 based on AEF details received in step 1 and CCF-B 506 information. At 518 (step 5), the AEF 504 requests security information from the CCF-A 508 by passing the CCB's information received in step 4 along with API invoker ID. At 520 and 522 (steps 6,7), the CCF-A 508 based on CCF-B's information received requests security information from the CCF-B 506.

At 524 (step 8), the CCF-B 506 sends the response by providing AEF_{PSK} to the CCF-A 508. At 526 (step 9), the CCF-A 508 sends the response to the AEF 504. At 528 (step 10), the AEF 504 sends the Authentication Initiation Response to the API invoker 502. At 530 (step 11), the TLS connection is established between the API invoker 502 and the AEF 504 using AEF_{PSK}.

An issue with the procedure 500 is the API invoker 502 does not know that the AEF 504 belongs to a different CCF (CCF-A 508) hence the API invoker 502 cannot include onboarded CCF information (CCF-B 506) to let the CCF-A 508 fetch from CCF-B 506 the security information related to the API invoker 502 to perform CAPIF-2/2e authentication and authorization. Hence CAPIF-2/2c authentication and authorization may fail between the API invoker 502 and the AEF 504 of CCF-A 508.

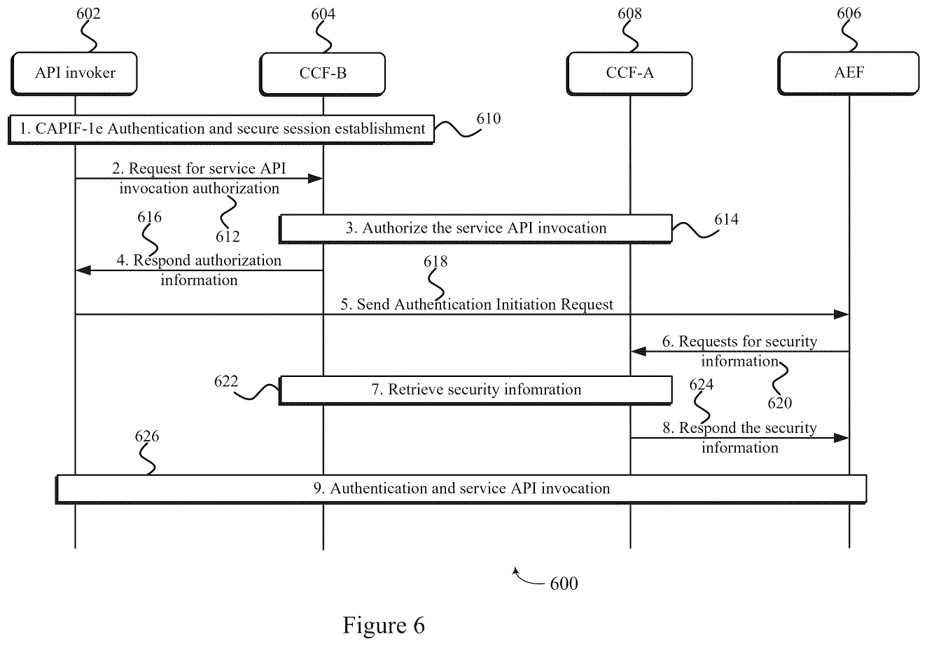

FIG. 6 illustrates an example procedure 600. The procedure 600 is a procedure for API invoker 602 authentication and authorization in CAPIF interconnection. Pre-conditions for the procedure 600 include: 1. the API invoker 602 has onboarded to the CCF-B 604; 2. the API invoker 602 has discovered service APIs provided by an AEF 606 via a procedure defined in step 1 and 2 of clause 8.25.3.3 of 3rd Generation Partnership Project (3GPP) technical specification (TS) 23.222; 3. the AEF 606 has registered to the CCF-A 608; and 4. the CCF-A and the CCF-B are connected to each other, and they have business agreement for service API authorization.

At 610 (step 1.), CAPIF-1e authentication and secure session is established as specified in subclause 6.3.1 of 3GPP TS 33.122. At 612 (step 2.), the API invoker 602 requests to the CCF-B 604 for obtaining authorization to access the service API published by the CCF-A 608 via CAPIF-6/6c. At 614 (step 3.), the CCF-B 604 requests the CCF-A 608 to authorize the service API invocation of the API invoker 602.

At 616 (step 4.), if the CCF-A 608 permits the service API invocation, the CCF-B 604 responds with the authorization information to the API invoker 602. At 618 (step 5.), the API invoker 602 sends Authentication Initiation Request to the AEF 606, including API invoker ID. At 620 (step 6.), the AEF 606 requests for security information from the CCF-A 608 to perform authentication and secure interface establishment with the API invoker 602.

At 622 (step 7.), the CCF-A 608 retrieves security information based on API invoker ID. If it has no security information, the CCF-A 608 requests for security information from the CCF-B 604 with API invoker ID. At 624 (step 8.), receiving the security information from the CCF-B 604, the CCF-A 608 responds to the AEF 606. At 626 (step 9.), authentication and secure interface establishment between the AEF 606 and the API invoker 602 is performed with the security information. The AEF 606 authorizes the API invoker's service API invocation request based on authorization information obtained from the CCF-A 608 as specified in subclause 8.16 of 3GPP TS 23.222.

An issue with procedure 600 is in step 5, the API invoker 602 will not know that certain AEF(s) are related to different CCF (say CCF-A 608) and hence it does not have sufficient information to include CCF-B 604 information in step 5 to let the CCF-A 608 retrieve security information from the CCF-B 604. Further, in step 7 the CCF-A 608 cannot retrieve security information based on API invoker ID from its local storage, as it has not fetched the security information from the CCF-B 604 before, so eventually the CCF-A 608 needs to request for security information from the CCF-B 604 with API invoker ID which may delay the service API Invocation time hence impacting the critical service experience.

The techniques discussed herein include TLS-PSK based CAPIF 2/2e authentication and authorization with various aspects to enable security information/authentication and authorization data transfer (e.g., AEF_{PSK}) between the API invoker onboarded CCF (e.g., also referred to as source CCF or CCF-A) and 3rd party CCF (e.g., also referred to as target CCF or CCF-B) which provides the service APIs via AEF to the API invoker. In one example, authentication initiation request forwarding along with security information from API invoker to AEF via CCF-A and CCF-B is described. In another example, API invoker or CCF-A triggered security information data transfer to CCF-B to enable CAPIF 2/2e authentication and authorization between the API invoker and the AEF of CCF-B is described. In another example, an API invoker includes CCF-A information (e.g., onboarded CCF ID/address information) in an authentication initiation request based on the service APIs/AEF being provided by CCF-B (as indicated during API invoker onboarding/security method negotiation) and/or based on security data sharing requirement indication per AEF received from the CCF-A (during security method negotiation) to enable CAPIF 2/2c authentication and authorization between the API invoker and the AEF of CCF-B.

The techniques discussed herein also include transport layer security public key infrastructure (TLS-PKI) based CAPIF 2/2e authentication and authorization with various aspects to enable security information/authentication and authorization data transfer (e.g., root certificate of CA to validate API invoker's certificate and if optionally API invoker's client certificate) between the API invoker onboarded CCF (e.g., also referred to as source CCF or CCF-A) and 3rd party CCF (e.g., also referred to as target CCF or CCF-B) which provides the service APIs via AEF to the API invoker. In one example, authentication initiation request forwarding along with security information from API invoker to AEF via CCF-A and CCF-B is described. In another example, API invoker or CCF-A triggered security information data transfer to CCF-B to enable CAPIF 2/2e authentication and authorization between the API invoker and the AEF of CCF-B is described. In another example, an API invoker includes CCF-A information (e.g., onboarded CCF ID/address information) in an authentication initiation request based on the service APIs/AEF being provided by CCF-B (as indicated during API invoker onboarding/security method negotiation) and/or based on security data sharing requirement indication per AEF received from the CCF-A (during security method negotiation) to enable CAPIF 2/2e authentication and authorization between the API invoker and the AEF of CCF-B.

The techniques discussed herein also include TLS with OAuth token based CAPIF 2/2c authentication and authorization with various aspects to enable security information/authentication and authorization data transfer (e.g., root certificate of CA to validate API invoker's certificate and if optionally API invoker's client certificate from CCF A to CCF-B, optionally OAuth access token from CCF-B to CCF-A) between the API invoker onboarded CCF (e.g., also referred to as source CCF or CCF-A) and 3rd party CCF (e.g., also referred to as target CCF or CCF-B) which provides the service APIs via AEF to the API invoker. In one example, on receiving an OAuth access token request from the API invoker, the CCF-A requests the access token from the CCF-B by providing the API invoker ID, service API information and AEF details used for the issue of OAuth access token by the CCF-B for the service API's provided by the CCF-B. In another example, during OAuth access token request/response or following a successful OAuth access token response being sent to the API invoker, the CCF-A provides the CCF-B with the security information to enable CAPIF 2/2e authentication and authorization between the API invoker and the AEF of CCF-B. Additionally, or alternatively, the API invoker based on service API information additionally includes CCF-A information in the service API invocation request to let the CCF-B fetch the security information from the CCF-A and to provide the security information to the CCF-B's AEF.

It should be noted that the security information discussed herein can also be referred to as authentication and authorization data.

It should also be noted that in the discussions herein, for the case of understanding, the CCF where the API invoker is onboarded or registered is also referred to as CCF-A, CCF-1, or source CCF. The other CCF, which provides the service APIs via the AEF(s) to the API invokers is also referred to as CCF-B, CCF-2, or target CCF.

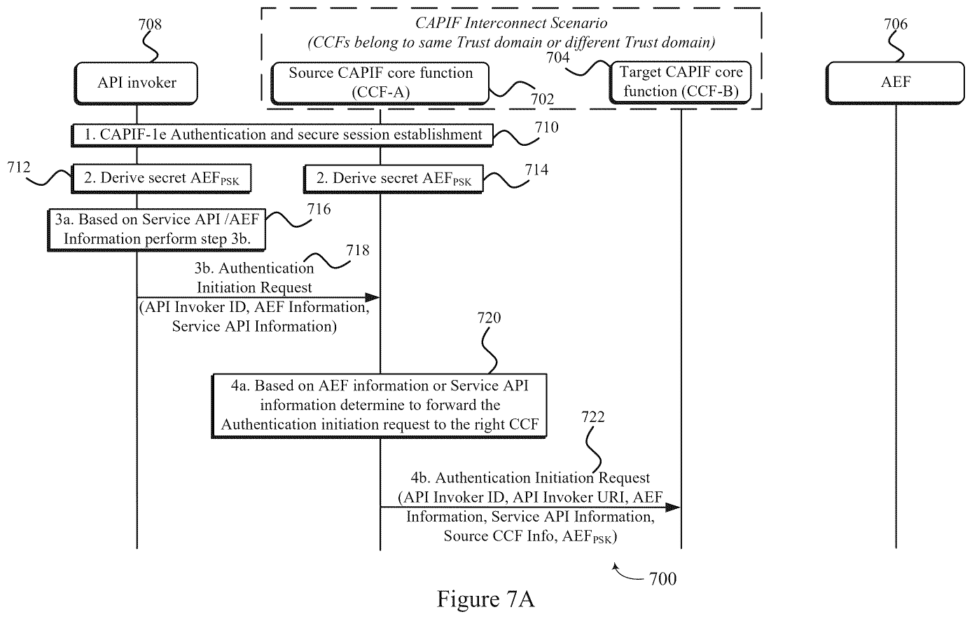

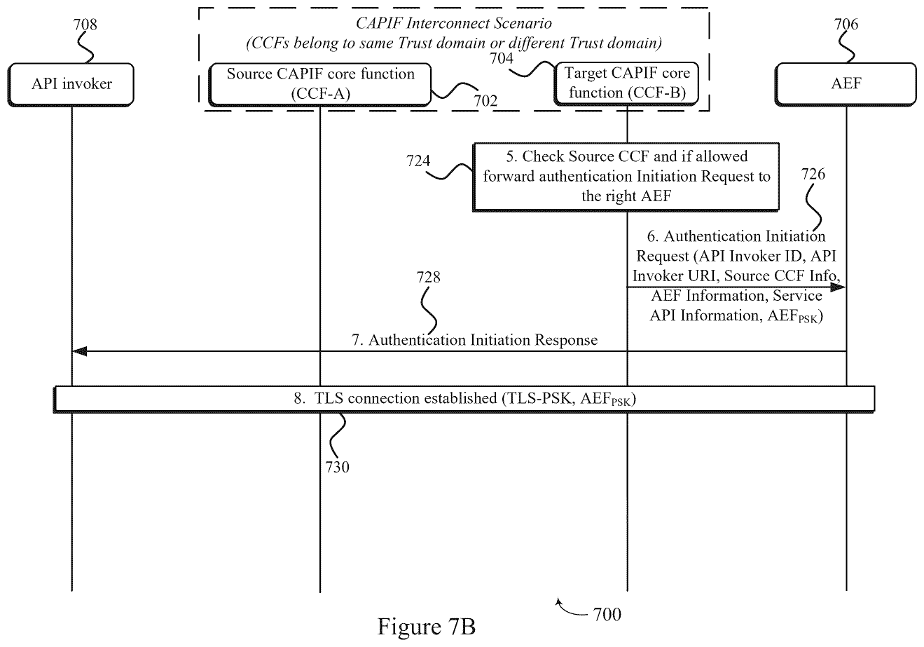

FIGS. 7A and 7B illustrate an example 700 of authentication and protection in a CAPIF interconnection scenario in accordance with aspects of the present disclosure. The example 700 illustrates CAPIF-2/2e interface authentication and protection using TLS-PSK in a CAPIF interconnection scenario. The example 700 illustrates, for TLS-PSK based CAPIF 2/2e authentication and authorization, various aspects to enable security information/authentication and authorization data transfer (e.g., an AEF_{PSK}) between an API invoker onboarded CCF (e.g., a source CCF or CCF-A 702) and a 3rd party CCF (e.g., a target CCF or CCF-B 704) which provides the service APIs via an AEF 706 to an API invoker 708. The CCF-A 702 and the CCF-B 704 can be in a same trust domain or in different trust domains. The example 700 illustrates authentication initiation request forwarding along with security information from the API invoker 708 to the AEF 706 via the CCF-A 702 and the CCF-B 704.

The API invoker 708 and the AEF 706 (of the CCF-B 704) can follow the procedure described below to establish a dedicated secure session using TLS connection based on pre-shared key. CAPIF-1e authentication (between the API invoker 708 and the CCF-A 702) can be used to bootstrap a pre-shared key for authenticating a TLS connection for CAPIF-2e (between the API invoker 708 and the AEF 706 belonging to the CCF-B 704). It is assumed that both the API invoker 708 and the CCF-A are pre-provisioned with certificates. The TLS profile as specified in Annex E of 3GPP TS 33.310 can be used.

The example 700 details the message flow between the API invoker 708, the CCF-A 702, the CCF-B 704 and the AEF 706 of the CCF-B 704, to establish secure CAPIF-2e interface using a pre-shared key for authentication.

At 710 (step 1.), a session between the API invoker 708 and the CCF-A 702 is established. In one or more implementations, a CAPIF-1e authentication and secure session is established between the API invoker 708 and its onboarded CCF-A 702. The CCF-A 702 can provide the validity timer value for the key AEF_{PSK}.

At 712 and 714 (Step 2.), a security key is derived. In one or more implementations, after successful establishment of TLS on CAPIF-1e, the API invoker 708 and the CCF-A 702 derive the key AEF_{PSK}. The key AEF_{PSK} is bound to the AEF 706, a CCF (in the case of CAPIF Interconnection, e.g., if the AEF 706/service API belongs to a CCF-B 704 which is different from the API invoker 708 onboarded CCF-A 702) and is derived as specified below. The API invoker 708 and the CCF-A 702 start the validity timer for the key AEF_{PSK}.

AEF_{PSK} key derivation can be performed using the key derivation function (KDF) specified in 3GPP TS 33.220. This subclause specifies how to construct the input string, S, to the KDF (which is input together with the relevant key). The FC number space is controlled by 3GPP TS 33.220.

AEF_{PSK} is derived by the API invoker 708 and the CCF-A 702 based on Service API interface information and CAPIF-1e TLS session parameters. Length and format of TLS session parameters used for key derivation are as specified in TLS. Security profiles for TLS implementation and usage follow the provisions given in 3GPP TS 33.310.

The following parameters are used to form the input S to the KDF:

FC = 0x7A
P0 = Service API interface information
L0 = Length of Service API interface information
P1 = CAPIF-1e TLS session's Session ID, generated as part of TLS full
Handshake.
L1 = Length of TLS Session ID
P2 = CCF-B ID/address (e.g., CCF ID/address which provides the Service
API/AEF 706).
L2 = Length of CCF-B ID/address.

It should be noted that P2 and L2 related to CCF-B 704 may be used as additional inputs by the API invoker 708 and the CCF-A 702 for the AEF_{PSK} generation in case of an CAPIF interconnection scenario, where the API invoker 708 and the CCF-A 702 determine that the service APIs/AEF 706 belong to a different CCF, e.g., CCF-B 704 and hence the key generation is bound to CCF-B ID/address. The input key can be equal to CAPIF-1e TLS session's Master Secret.

At 716 (step 3a.), the API invoker 708 determines whether to send an authentication initiation request. In one or more implementations, the API invoker 708 checks if the service APIs/AEF 706 belong to the onboarded CCF (e.g., CCF-A 702) or belong to any 3rd party CCF (e.g., CCF-B 704). If the service APIs/AEF 706 belong to the 3rd party CCF (e.g., CCF-B 704), the API invoker 708 determines to send the (CAPIF 2/2e related) authentication initiation request to the CCF-A 702.

At 718 (step 3b.), the API invoker 708 communicates (e.g., transmits or sends) an authentication initiation request. In one or more implementations, the API invoker 708 sends an authentication initiation request to the CCF-A 702, including the CCF-A 702 assigned API invoker ID, AEF 706 details (as received from the CCF-A 702 during the onboarding, where AEF 706 details include AEF 706 IDs, the 3rd party/designated CCF-B ID/address per service API/AEF 706 in case the service API/AEF 706 belongs to CCF-B 704), and service API information.

Steps 1 and 2 (at 710, 712, and 714) of the example 700 may be skipped if the API invoker 708 is already in possession of a valid key AEF_{PSK}. In this case, the API invoker 708 begins the procedure at 716 (step 3a.).

At 720 (step 4a.), a determination is made as to where to communicate (e.g., transmit or send) an authentication initiation request. In one or more implementations, based on AEF 706 information or service API information, the CCF-A 702 determines to forward the authentication initiation request to the right CCF (e.g., CCF-B 704 in this example) which is responsible for the AEF 706 along with the necessary security information for the selected security method e.g., security information (TLS-PSK: AEF_{PSK}) for the AEF 706.

At 722 (step 4b.) an authentication initiation request is communicated (e.g., transmitted or sent). In one or more implementations, the CCF-A 702 sends the authentication initiation request to the CCF-B 704, including the CCF-A 702 assigned API invoker ID, the API invoker URI, the AEF 706 details (as received from the CCF-A 702 during the onboarding, where the AEF 706 details includes AEF IDs, the 3rd party/designated CCF-B ID/address per service API/AEF 706 in case the service API/AEF 706 belongs to CCF-B 704), the service API information, the source/onboarded CCF ID/Address (e.g., CCF-A 702 ID/address), the security information (TLS-PSK: AEF_{PSK}), and the validity timer value.

At 724 (step 5.), a check is made as to whether to forward the authentication initiation request. In one or more implementations, the CCF-B 704 checks if the source CCF-A 702 is allowed to request the CAPIF-2/2e authentication for the listed service APIs/AEF 706 and if allowed to forward the related authentication initiation request based on the local access policy stored for the CAPIF interconnection. Meanwhile the CCF-B 704 stores the API invoker ID, the API invoker URI, the Source CCF Info, the AEF 706 Information, the service API information, the security information (TLS-PSK: AEF_{PSK}), and the validity timer value.

At 726 (step 6.), the authentication initiation request is forwarded (e.g., communicated, transmitted, sent). In one or more implementations, if it is allowed, the CCF-B 704 considers the check as successful and sends an authentication initiation request to the AEF 706, which includes the API invoker ID, the API invoker URI, the source CCF info, the AEF 706 information, the service API Information, the security information (TLS-PSK: AEF_{PSK}), and the validity timer value.

At 728 (step 7.), an authentication initiation response is communicated (e.g., transmitted, sent). In one or more implementations, after receiving the authentication initiation request with the relevant security information (AEF_{PSK}) for the authentication, the AEF 706 sends an authentication initiation response message to the API invoker 708 to initiate the TLS session establishment. The AEF 706 starts the validity timer based on the value received from the CCF-A 702 (e.g., via CCF-A 702 in step 6).

At 730 (step 8.), mutual authentication is performed. In one or more implementations, the API invoker 708 and the AEF 706 perform mutual authentication using the key AEF_{PSK} and establish TLS session over the CAPIF-2c.

After successful establishment of TLS on CAPIF-2e reference point, the AEF 706 authorizes the API invoker 708's service API invocation request based on authorization information obtained from the CCF-B 704 as specified in subclause 8.16 of 3GPP TS 23.222.

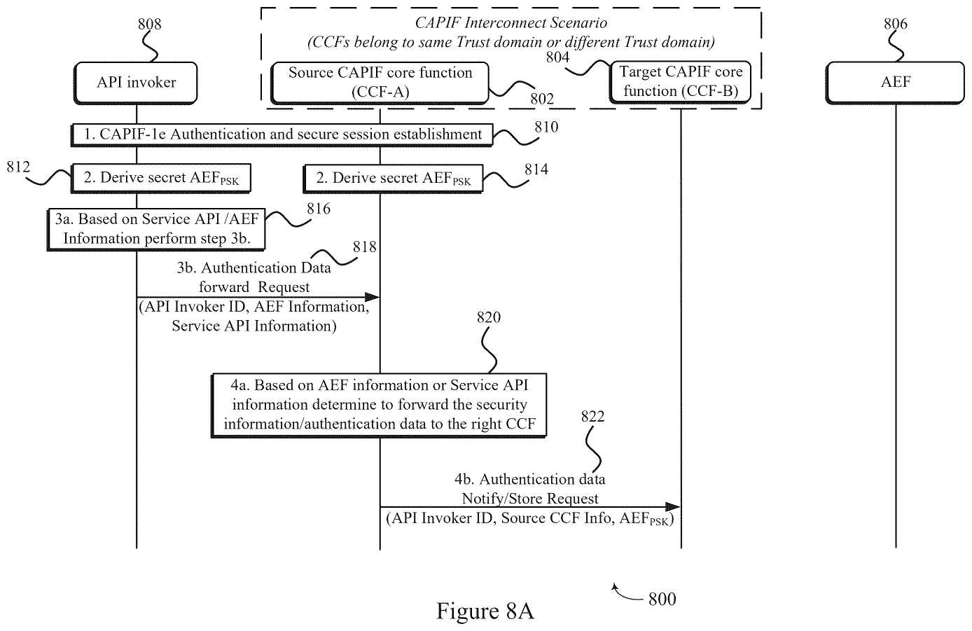

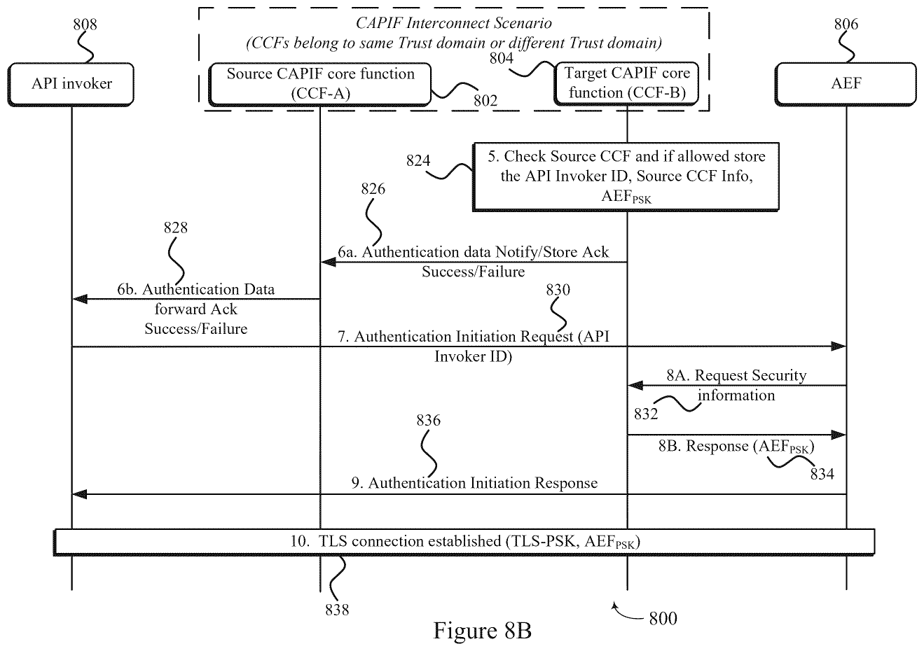

FIGS. 8A and 8B illustrate another example 800 of authentication and protection in a CAPIF interconnection scenario in accordance with aspects of the present disclosure. The example 800 illustrates CAPIF-2/2e interface authentication and protection using TLS-PSK in a CAPIF interconnection scenario. The example 800 illustrates, for TLS-PSK based CAPIF 2/2c authentication and authorization, various aspects to enable security information/authentication and authorization data transfer (e.g., a AEF_{PSK}) between an API invoker onboarded CCF (e.g., a source CCF or CCF-A 802) and a 3rd party CCF (e.g., a target CCF or CCF-B 804) which provides the service APIs via an AEF 806 to an API invoker 808. The CCF-A 802 and the CCF-B 804 can be in a same trust domain or in different trust domains. The example 800 illustrates API invoker 808 or CCF-A 802 triggered security information data transfer to the CCF-B 804 to enable CAPIF 2/2c authentication and authorization between the API invoker 808 and the AEF 806 of the CCF-B 804.

The API invoker 808 registered/onboarded in CCF-A 802 and the API exposing function of 3rd party CCF-B 804 follow the flow illustrated in example 800 to establish dedicated secure session using TLS connection based on pre-shared key. CAPIF-1e authentication shall be used to bootstrap a pre-shared key for authenticating a TLS connection for CAPIF-2e (between API invoker 808 and AEF 806 belonging to CCF-B 804). It is assumed that both the API invoker 808 and the CCF-A 802 are pre-provisioned with certificates. The TLS profile as specified in Annex E of TS 33.310 shall be used.

The example 800 details the message flow between the API invoker 808, the CCF-A 802, the CCF-B 804 and the AEF 806 of the CCF-B 804, to establish secure CAPIF-2e interface using a pre-shared key for authentication.

At 810 (step 1.), a session between the API invoker 808 and the CCF-A 802 is established. In one or more implementations, a CAPIF-1e authentication and secure session is established between the API invoker 808 and its onboarded CCF-A 802. The CCF-A 802 can provide the validity timer value for the key AEF_{PSK}.

At 812 and 814 (Step 2.), a security key is derived. In one or more implementations, after successful establishment of TLS on CAPIF-1e, the API invoker 808 and the CCF-A 802 derive the key AEF_{PSK}. The key AEF_{PSK} is bound to the AEF 806, a CCF (in case of CAPIF Interconnection, e.g., if the AEF 806/service API belongs to a CCF-B 804 which is different from the API invoker 808 onboarded CCF-A 802) and is derived as discussed above with reference to 712 and 714 of example 700. The API invoker 808 and the CCF-A 802 start the validity timer for the key AEF_{PSK}.

At 816 (step 3a.), the API invoker 808 determines whether to send an authentication data forward request. In one or more implementations, the API invoker 808 checks if the service APIs/AEF 806 belong to the onboarded CCF (e.g., CCF-A 802) or belong to any 3rd party CCF (e.g., CCF-B 804). If the service APIs/AEF 806 belong to the 3rd party CCF (e.g., CCF-B 804), the API invoker 808 determines to trigger/initiate the (CAPIF 2/2e related security information) authentication data forward request to the CCF-A 802.

At 818 (step 3b.), the API invoker 808 communicates (e.g., transmits or sends) an authentication data forward request. In one or more implementations, the API invoker 808 sends an authentication data/security information forward request to the CCF-A 802, including the CCF-A 802 assigned API invoker ID, AEF 806 details (as received from the CCF-A 802 during the onboarding, where AEF 806 details include AEF IDs, the 3rd party/designated CCF-B ID/address per service API/AEF 806 in case the service API/AEF 806 belongs to CCF-B 804), and service API information.

At 820 (step 4a.), a determination is made as to whether to communicate (e.g., transmit or send) an authentication data forward request. In one or more implementations, based on AEF 806 information or service API information, CCF-A 802 determines to forward the authentication data/security information forward request to the right CCF (e.g., CCF-B 804 in this example) which is responsible for the AEF 806 along with the necessary security information for the selected security method e.g., security information (TLS-PSK: AEF_{PSK}) for the AEF 806.

At 822 (step 4b.), an authentication data notify or store request is communicated (e.g., transmitted or sent). In one or more implementations, the CCF-A 802 sends the authentication data/security information forward request to the CCF-B 804, including the CCF-A 802 assigned API invoker ID, the AEF 806 details (as received from the CCF-A 802 during the onboarding, where AEF 806 details include AEF IDs, the 3rd party/designated CCF-B ID/address per service API/AEF 806 in case the service API/AEF 806 belongs to CCF-B 804), the service API information, the source/onboarded CCF ID/Address (e.g., CCF-A 802 ID/address), the security information (TLS-PSK: AEF_{PSK}), and validity timer value.

At 824 (step 5.), a check is made as to whether to perform the request. In one or more implementations, the CCF-B 804 checks if the source CCF-A 802 is allowed to do the authentication data/security information forward request for CAPIF-2/2e authentication for the listed service APIs/AEF 806 and if allowed to forward the related authentication data/security information based on the local access policy stored for the CAPIF interconnection, the CCF-B 804 stores the API invoker ID, the Source CCF Info, the AEF 806 Information, the service API information, the security information (TLS-PSK: AEF_{PSK}), and the validity timer value.

At 826 (step 6a.), a success or failure indication is communicated (e.g., transmitted, sent). In one or more implementations, following a successful authentication data/security information storage for the API invoker ID, the CCF-B 804 sends to the CCF-A 802 a success indication in the authentication data/security information notify/store acknowledgement message. Otherwise, a failure is sent.

At 828 (step 6b.), the success or failure indication is further communicated (e.g., transmitted, sent). In one or more implementations, if a successful authentication data/security information notify/store acknowledgement message is received, the CCF-A 802 sends to the API invoker 808 a success indication in the authentication data/security information forward acknowledgement message. Otherwise, a failure is sent.

At 830 (step 7.), an authentication initiation request is communicated (e.g., transmitted, sent). In one or more implementations, if a success indication is received at 828, the API invoker 808 sends an authentication initiation request to the AEF 806, including the CCF assigned API invoker ID.

It should be noted that steps 1 and 2 (at 810, 812, and 814) of the example 800 may be skipped if the API invoker 808 is already in possession of a valid key AEF_{PSK}. In this case, the API invoker 808 begins the procedure at 816 (step 3a).

At 832 and 834 (steps 8A and 8B), the AEF 806 communicates (e.g., transmits, receives) a request for security information and receives a response. In one or more implementations, the AEF 806 requests for security information from the CCF-B 804 to perform authentication and secure interface establishment with the API invoker 808, if the AEF 806 does not have a valid key. The CCF-B 804 provides the security information related to the chosen security method (TLS-PSK: AEF_{PSK}) to the AEF 806 over CAPIF-3 reference point. The CCF-B 804 provides the remaining validity timer value for the key AEF_{PSK}.

At 836 (step 9.), an authentication indication response is communicated (e.g., transmitted, sent). In one or more implementations, after fetching the relevant security information (AEF_{PSK}) for the authentication, the AEF 806 sends an authentication initiation response message to the API invoker 808 to initiate the TLS session establishment. The AEF 806 starts the validity timer based on the value received from the CCF-B 804 (e.g., in step 8B).

At 838 (step 10), mutual authentication is performed. In one or more implementations, the API invoker 808 and the AEF 806 perform mutual authentication using the key AEF_{PSK} and establish TLS session over the CAPIF-2e.

After successful establishment of TLS on CAPIF-2e reference point, the AEF 806 authorizes the API invoker 808's service API invocation request based on authorization information obtained from the CCF-B 804 as specified in subclause 8.16 of 3GPP TS 23.222.

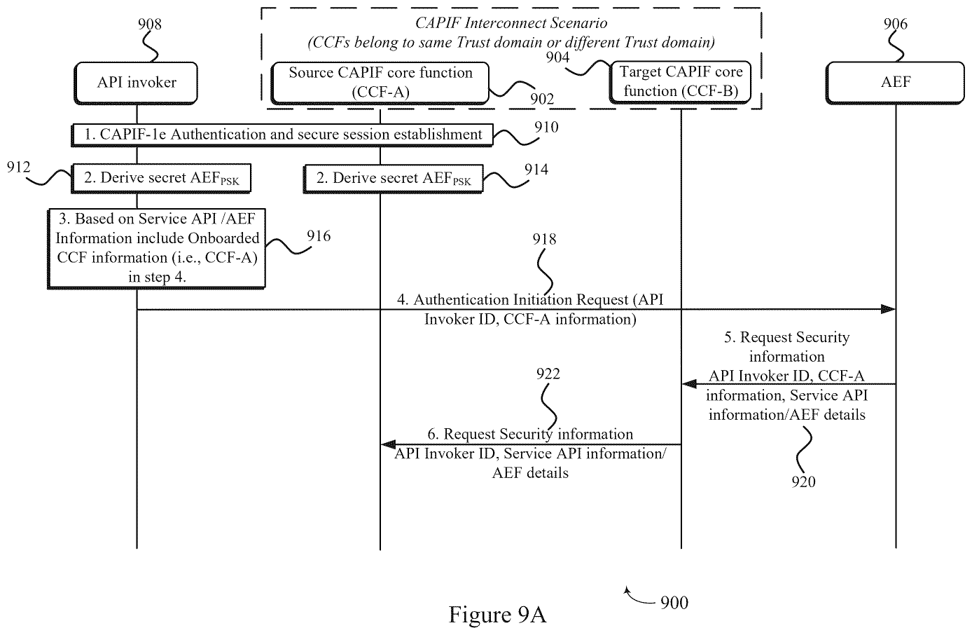

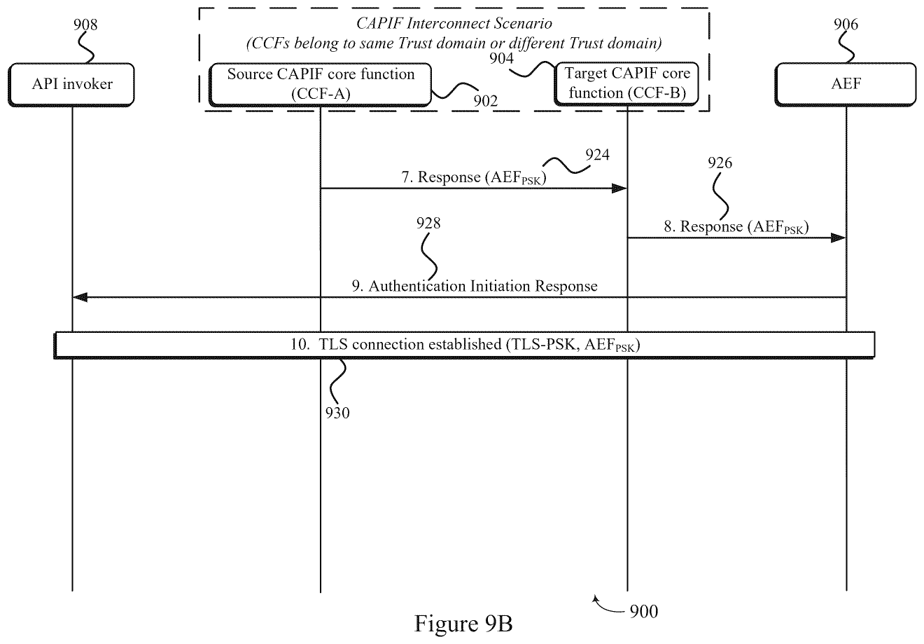

FIGS. 9A and 9B illustrate another example 900 of authentication and protection in a CAPIF interconnection scenario in accordance with aspects of the present disclosure. The example 900 illustrates CAPIF-2/2e interface authentication and protection using TLS-PSK in a CAPIF interconnection scenario. The example 900 illustrates, for TLS-PSK based CAPIF 2/2c authentication and authorization, various aspects to enable security information/authentication and authorization data transfer (e.g., an AEF_{PSK}) between an API invoker onboarded CCF (e.g., a source CCF or CCF-A 902) and a 3rd party CCF (e.g., a target CCF or CCF-B 904) which provides the service APIs via an AEF 906 to an API invoker 908. The CCF-A 902 and the CCF-B 904 can be in a same trust domain or in different trust domains.

The example 900 illustrates the API invoker 908 includes CCF-A 902 information (e.g., onboarded CCF ID/address information) in an authentication initiation request based on the service APIs/AEF 906 being provided by the CCF-B 904 (as indicated during API invoker onboarding/security method negotiation) and/or based on security data sharing requirement indication per AEF received from the CCF-A 902 (during security method negotiation) to enable CAPIF 2/2c authentication and authorization between the API invoker 908 and the AEF 906 of the CCF-B 904. It should be noted that security data sharing requirement indication per AEF can also be referred to as CAPIF interconnection indication.

At 910 (step 1.), a session between the API invoker 908 and the CCF-A 902 is established. In one or more implementations, CAPIF-1e authentication and secure session is established between the API invoker 908 and its onboarded CCF-A 902. The CCF-A 902 can provide the validity timer value for the key AEF_{PSK}.

At 912 and 914 (step 2.), a security key is derived. In one or more implementations, after successful establishment of TLS on CAPIF-1e, the API invoker 908 and the CCF-A 902 derive the key AEF_{PSK}. The key AEF_{PSK} is bound to the AEF 906, a CCF (in case of CAPIF Interconnection, e.g., if the AEF 906/service API belongs to a CCF-B 904 which is different from the API invoker 908 onboarded CCF-A 902) and is derived as discussed above with reference to 712 and 714 of example 700. The API invoker 908 and the CCF-A 902 start the validity timer for the key AEF_{PSK}.

At 916 (step 3), a check is made as to which CCF the service APIs/AEF belong to. In one or more implementations, the API invoker 908 checks if the service APIs/AEF 906 belong to the onboarded CCF (e.g., CCF-A 902) or belong to any 3rd party CCF (e.g., CCF-B 904). If the service APIs/AEF 906 belong to the 3rd party CCF (e.g., CCF-B 904), the API invoker 908 determines to include CCF-B ID/address in the authentication initiation request at 918 (step 4). For example, based on service API/AEF 906 information, the API invoker 908 determines to include onboarded CCF information (e.g., CCF-A 902) at 918 (step 4).

It should be noted that the API invoker 908 includes CCF-A 902 information (e.g., onboarded CCF ID/address information) in the authentication initiation request based on the service APIs/AEF 906 being provided by CCF-B 904 (as indicated during API invoker 908 onboarding/security method negotiation) and/or based on security data sharing requirement indication per AEF 906 received from the CCF-A 902 (during security method negotiation) to enable CAPIF 2/2c authentication and authorization between the API invoker 908 and the AEF 906 of CCF-B 904.

At 918 (step 4.), an authentication initiation request is communicated (e.g., transmitted, sent). In one or more implementations, the API invoker 908 sends an authentication initiation request to the AEF 906, including the CCF assigned API invoker ID and onboarded CCF Information, e.g., CCF-A 902 ID/address.

It should be noted that steps 1 and 2 (at 910, 912, and 914) of the example 900 this be skipped if the API invoker 908 is already in possession of a valid key AEF_{PSK}. In this case, the API invoker 908 begins the procedure at 916 (step 3).

At 920 (step 5.), the AEF 906 communicates (e.g., transmits, sends) a request for security information. In one or more implementations, the AEF 906 sends a request security information message which includes the API invoker ID, CCF-A ID/address, service API information (names), AEF 906 details (IDs) to request for security information from the CCF-B 904 to perform authentication and secure interface establishment with the API invoker 908, if the AEF 906 does not have a valid key.

At 922 (step 6.), the CCF-B 904 communicates (e.g., transmits, sends) a request for security information. In one or more implementations, if the CCF-B 904 finds that it does not have any security information related to the API invoker 908, the CCF-B 904 contacts the CCF-A 902 based on the CCF-A 902 information (e.g., ID/address). The CCF-B 904 sends the request security information message to CCF-A 902, which includes the API invoker ID, service API information (names), and AEF 906 details (IDs) to request for security information from the CCF-B 904.

At 924 and 926 (steps 7 and 8), a response to the request for security information is communicated (e.g., transmitted, received). In one or more implementations, the CCF-A 902 fetches the security information service API information (names), and AEF 906 details (IDs) (based on the received service API information (names), and AEF 906 details (IDs)) and related to the API invoker 908 ID and further provides the security information related to the chosen security method (TLS-PSK: AEF_{PSK}) to the CCF-B 904 in a response message over CAÜPIF-6/6e interface. Further the CCF-B 904 sends the security information related to the chosen security method (TLS-PSK: AEF_{PSK}) in a response message to the AEF 906 over CAPIF-3 reference point. The CCF provides the remaining validity timer value for the key AEF_{PSK}.

At 928 (step 9.), an authentication indication response is communicated (e.g., transmitted, sent). In one or more implementations, after fetching the relevant security information (AEF_{PSK}) for the authentication, the AEF 906 sends an authentication initiation response message to the API invoker 908 to initiate the TLS session establishment. The AEF 906 starts the validity timer based on the value received from the CCF-A 902 or CCF-B 904 in step 8.

At 930 (step 10), mutual authentication is performed. In one or more implementations, the API invoker 908 and the AEF 906 perform mutual authentication using the key AEF_{PSK} and establish TLS session over the CAPIF-2c.

After successful establishment of TLS on CAPIF-2e reference point, the AEF 906 authorizes the API invoker 908's service API invocation request based on authorization information obtained from the CCF-B 904 as specified in subclause 8.16 of 3GPP TS 23.222.

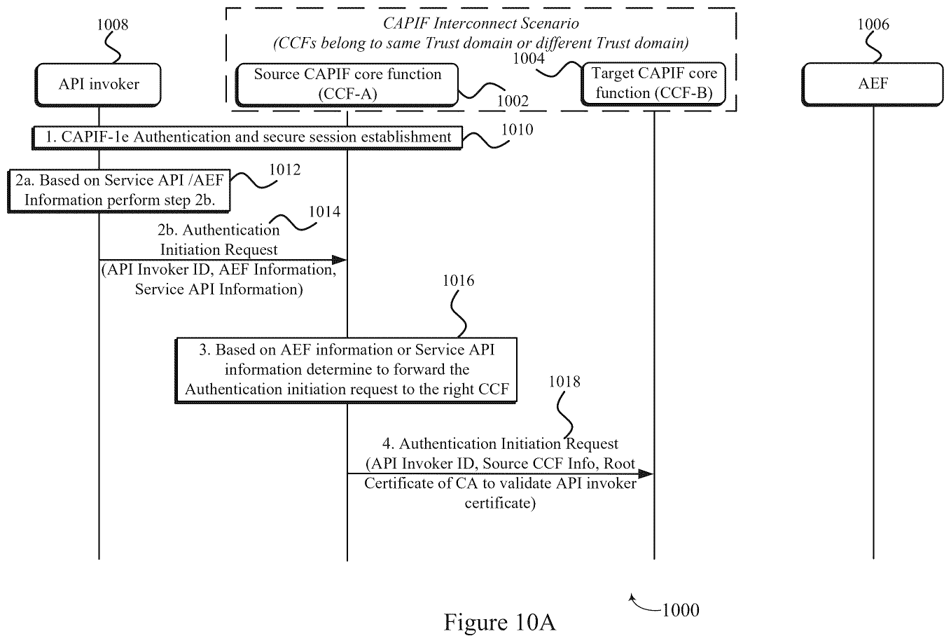

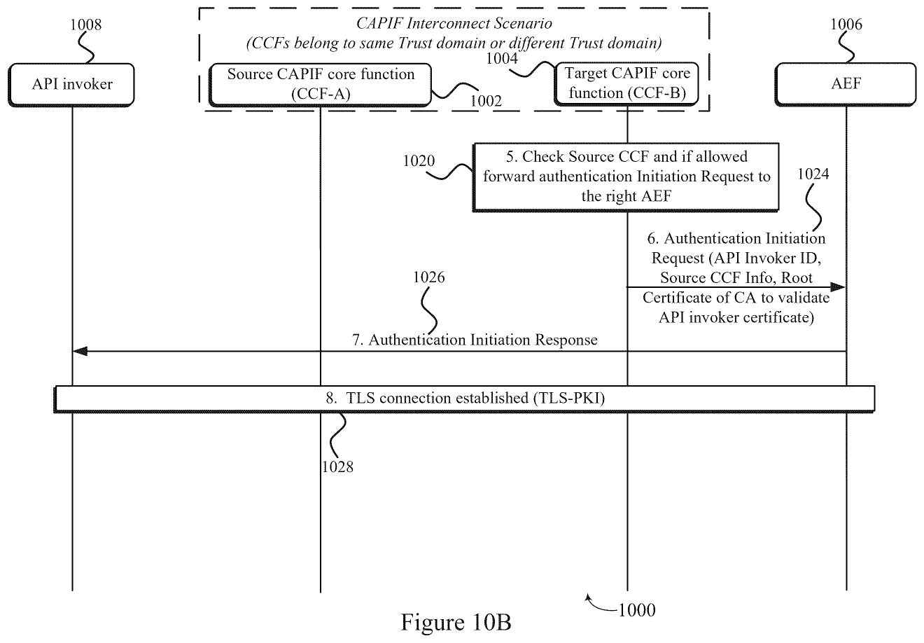

FIGS. 10A and 10B illustrate an example 1000 of authentication and protection in a CAPIF interconnection scenario in accordance with aspects of the present disclosure. The example 1000 illustrates CAPIF-2/2e interface authentication and protection using certificate based mutual authentication in a CAPIF interconnection scenario. The example 1000 illustrates, for TLS-PKI based CAPIF 2/2e authentication and authorization, various aspects to enable security information/authentication and authorization data transfer (e.g., root certificate of CA to validate API invoker's certificate and if needed API invoker's client certificate) between an API invoker onboarded CCF (e.g., a source CCF or CCF-A 1002) and a 3rd party CCF (e.g., a target CCF or CCF-B 1004) which provides the service APIs via an AEF 1006 to an API invoker 1008. The CCF-A 1002 and the CCF-B 1004 can be in a same trust domain or in different trust domains. The example 1000 illustrates authentication initiation request forwarding along with security information from the API invoker 1008 to the AEF 1006 via the CCF-A 1002 and the CCF-B 1004.

The API invoker 1008 and the AEF 1006 of the CCF-B 1004 can follow the procedure described below to establish a dedicated secure session over CAPIF-2e using TLS based on certificate based mutual authentication. It is assumed that both the API invoker 1008 and the AEF 1006 are pre-provisioned with certificates.

The example 1000 details the message flow between the API invoker 1008, the CCF-A 1002, the CCF-B 1004, and the AEF 1006 of the CCF-B 1004 related to this security method.

At 1010 (step 1.), a session between the API invoker 1008 and the CCF-A 1002 is established. In one or more implementations, a CAPIF-1e authentication and secure session is established between the API invoker 1008 and it's onboarded CCF-A 1002.

At 1012 (step 2a.), a check is made as to which CCF the service APIs/AEF belong to. In one or more implementations, the API invoker 1008 checks if the service APIs/AEF 1006 belong to the onboarded CCF (e.g., CCF-A 1002) or belong to any 3rd party CCF (e.g., CCF-B 1004). If the service APIs/AEF 1006 belong to the 3rd party CCF (e.g., CCF-B 1004), the API invoker 1008 determines to send the (CAPIF 2/2e related) authentication initiation request to the CCF-A 1002.

At 1014 (step 2b.), an authentication initiation request is communicated (e.g., transmitted, sent). In one or more implementations, the API invoker 1008 sends an authentication initiation request to the CCF-A 1002, including the CCF-A 1002 assigned API invoker ID, AEF 1006 details (as received from the CCF-A 1002 during the onboarding, where the AEF 1006 details include AEF IDs, the 3rd party/designated CCF-B 1004 ID/address per service API/AEF 1006 in case the service API/AEF 1006 belongs to CCF-B 1004), and service API information.

At 1016 (step 3.), a determination is made as to where to communicate (e.g., transmit or send) an authentication initiation request. In one or more implementations, based on AEF 1006 information or service API information, the CCF-A 1002 determines to forward the authentication initiation request to the right CCF (e.g., CCF-B 1004 in this example) which is responsible for the AEF 1006 along with the necessary security information related to the chosen security method (TLS-PKI) e.g., API invoker 1008's root CA certificate for the AEF 1006 to validate the API invoker 1008's certificate.

At 1018 (step 4.), an authentication initiation request is communicated (e.g., transmitted or sent). In one or more implementations, the CCF-A 1002 sends the authentication initiation request to the CCF-B 1004, including the CCF-A 1002 assigned API invoker ID, API invoker URI, AEF 1006 details (as received from the CCF-A 1002 during the onboarding, where the AEF 1006 details include AEF IDs, the 3rd party/designated CCF-B 1004 ID/address per service API/AEF 1006 in case the service API/AEF 1006 belongs to the CCF-B 1004), service API information, source/onboarded CCF ID/Address (e.g., CCF-A 1002 ID/address), and security information related to the chosen security method (TLS-PKI) e.g., API invoker 1008's root CA certificate for the AEF 1006 to validate the API invoker 1008's certificate.

At 1020 (step 5.), a check is made as to whether to forward the authentication initiation request. In one or more implementations, the CCF-B 1004 checks if the source CCF-A 1002 is allowed to request the CAPIF-2/2e authentication for the listed service APIs/AEF 1006 and if allowed to forward the related authentication initiation request based on the local access policy stored for the CAPIF interconnection. Meanwhile the CCF-B 1004 stores the API invoker ID, API invoker URI, Source CCF Info, AEF 1006 Information, the service API Information, and security information related to the chosen security method (TLS-PKI) e.g., API invoker 1008's root CA certificate for the AEF 1006 to validate the API invoker's certificate.

At 1024 (step 6.), the authentication initiation request is forwarded (e.g., communicated, transmitted, sent). In one or more implementations, if it is allowed, the CCF-B 1004 considers the check as successful and sends an authentication initiation request to the AEF 1006, which includes the API invoker ID, the API invoker URI, the Source CCF Info, AEF 1006 Information, the Service API Information, and security information related to the chosen security method (TLS-PKI) e.g., API invoker's root CA certificate for the AEF 1006 to validate the API invoker's certificate.

At 1026 (step 7.), an authentication initiation response is communicated (e.g., transmitted, sent). In one or more implementations, after receiving the relevant security information for the authentication, the AEF 1006 sends an authentication initiation response message to the API invoker 1008 to initiate the TLS session establishment procedure.

At 1028 (step 8.), mutual authentication is performed. In one or more implementations, the API invoker 1008 and the AEF 1006 perform mutual authentication using certificates and establish TLS session over the CAPIF-2e. Certificate based authentication follows the profiles given in 3GPP TS 33.310, clauses 6.1.3a and 6.1.4a.

After successful establishment of TLS on CAPIF-2e reference point, the AEF 1006 authorizes the API invoker 1008's service API invocation request based on authorization information obtained from CAPIF core function as specified in subclause 8.16 of 3GPP TS 23.222.

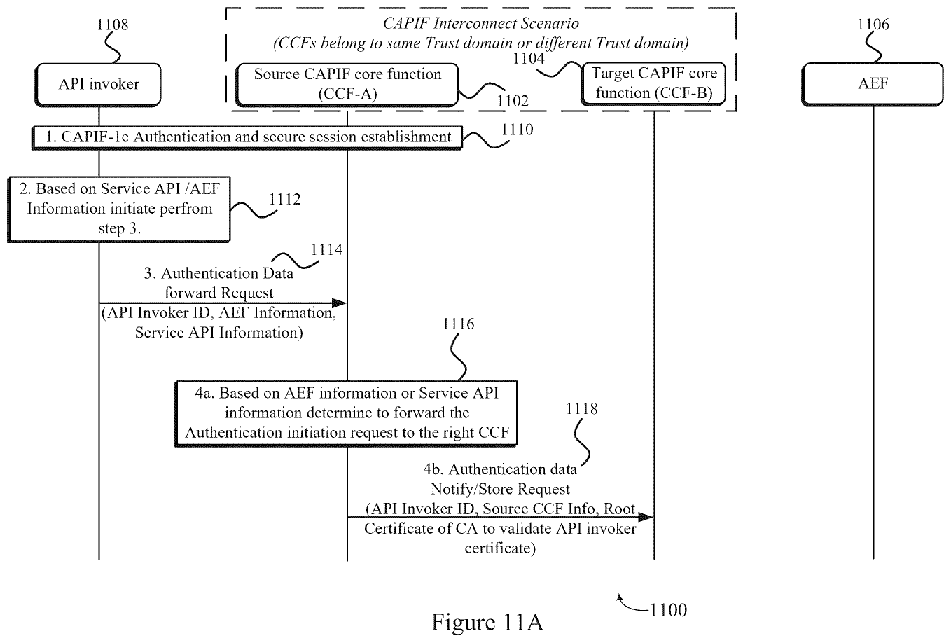

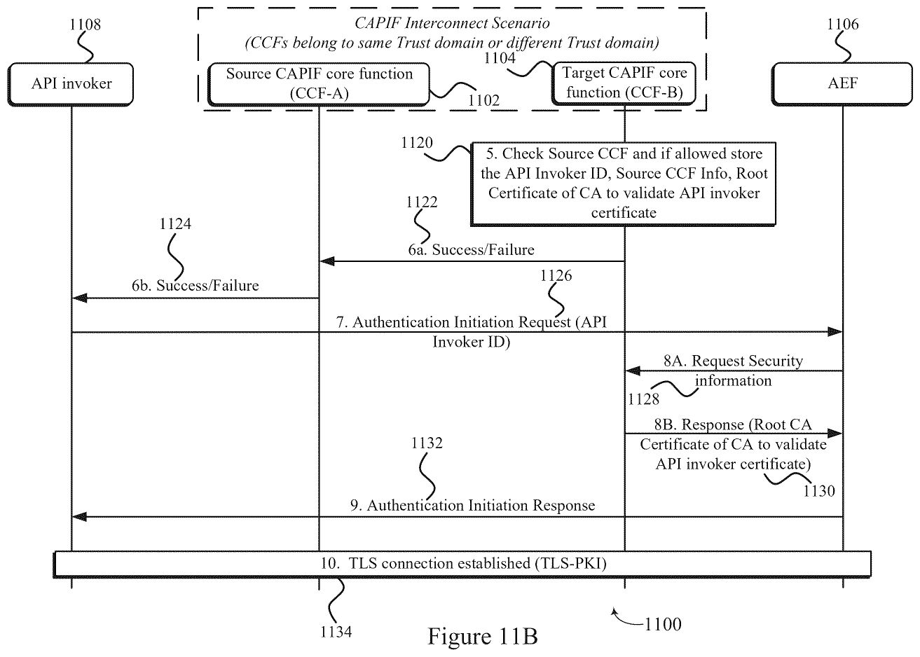

FIGS. 11A and 11B illustrate an example 1100 of authentication and protection in a CAPIF interconnection scenario in accordance with aspects of the present disclosure. The example 1100 illustrates CAPIF-2/2e interface authentication and protection using certificate based mutual authentication in a CAPIF interconnection scenario. The example 1100 illustrates, for TLS-PKI based CAPIF 2/2e authentication and authorization, various aspects to enable security information/authentication and authorization data transfer (e.g., root certificate of CA to validate API invoker's certificate and if needed API invoker's client certificate) between an API invoker onboarded CCF (e.g., a source CCF or CCF-A 1102) and a 3rd party CCF (e.g., a target CCF or CCF-B 1104) which provides the service APIs via an AEF 1106 to an API invoker 1108. The CCF-A 1102 and the CCF-B 1104 can be in a same trust domain or in different trust domains. The example 1100 illustrates API invoker 1108 or CCF-A 1102 triggered security information data transfer to the CCF-B 1104 to enable CAPIF 2/2e authentication and authorization between the API invoker 1108 and the AEF 1106 of the CCF-B 1104.

The API invoker 1108 and the AEF 1106 follow the flow illustrated in example 1100 to establish dedicated secure session over CAPIF-2e using TLS based on certificate based mutual authentication. It is assumed that both the API invoker 1108 and the AEF 1106 are pre-provisioned with certificates.

The example 1100 details the message flow between the API invoker 1108, the CCF-A 1102, the CCF-B 1104, and the AEF 1106 related to this security method.

At 1110 (step 1.), a session between the API invoker 1108 and the CCF-A 1102 is established. In one or more implementations, a CAPIF-1e authentication and secure session is established between the API invoker 1108 and its onboarded CCF-A 1102.

At 1112 (step 2.), a check is made as to which CCF the service APIs/AEF belong to. In one or more implementations, the API invoker 1108 checks if the service APIs/AEF 1106 belong to the onboarded CCF (e.g., CCF-A 1102) or belong to any 3rd party CCF (e.g., CCF-B 1104). If the service APIs/AEF 1106 belong to the 3rd party CCF (e.g., CCF-B 1104), the API invoker 1108 determines to trigger/initiate the (CAPIF 2/2e related security information) authentication data forward request to the CCF-A 1102.

At 1114 (step 3.), the API invoker 1108 communicates (e.g., transmits or sends) an authentication data forward request. In one or more implementations, the API invoker 1108 sends an authentication data/security information forward request to the CCF-A 1102, including the CCF-A 1102 assigned API invoker ID, AEF 1106 details (as received from the CCF-A 1102 during the onboarding, where AEF 1106 details includes AEF IDs, the 3rd party/designated CCF-B ID/address per service API/AEF 1106 in case the service API/AEF 1106 belongs to CCF-B 1104), and service API information.

At 1116 (step 4a.), a determination is made as to whether to communicate (e.g., transmit or send) an authentication data forward request. In one or more implementations, based on AEF 1106 information or Service API information, CCF-A 1102 determines to forward the authentication data/security information forward request to the right CCF (e.g., CCF-B 1104 in this example) which is responsible for the AEF 1106 along with the necessary security information related to the chosen security method (TLS-PKI) e.g., API invoker's root CA certificate for the AEF 1106 to validate the API invoker's certificate.

At 1118 (step 4b.), an authentication data notify or store request is communicated (e.g., transmitted or sent). In one or more implementations, the CCF-A 1102 sends the authentication data/security information forward request to the CCF-B 1104, including the CCF-A 1102 assigned API invoker ID, AEF 1106 details (as received from the CCF-A 1102 during the onboarding, where AEF 1106 details includes AEF IDs, the 3rd party/designated CCF-B ID/address per service API/AEF 1106 in case the service API/AEF 1106 belongs to CCF-B 1104), service API information, source/onboarded CCF ID/Address (e.g., CCF-A ID/address), security information related to the chosen security method (TLS-PKI) e.g., API invoker's root CA certificate for the AEF 1106 to validate the API invoker's certificate.

At 1120 (step 5.), a check is made as to whether to perform the request. In one or more implementations, the CCF-B 1104 checks if the source CCF-A 1102 is allowed to do authentication data/security information forward request for CAPIF-2/2e authentication for the listed service APIs/AEF 1106 and if allowed to forward the related authentication data/security information based on the local access policy stored for the CAPIF interconnection, the CCF-B 1104 stores the API invoker ID, Source CCF Info, AEF 1106 Information, security information related to the chosen security method (TLS-PKI) e.g., API invoker's root CA certificate for the AEF 1106 to validate the API invoker's certificate.

At 1122 (step 6a.), a success or failure indication is communicated (e.g., transmitted, sent). In one or more implementations, following a successful authentication data/security information storage for the API invoker ID, the CCF-B 1104 sends to the CCF-A 1102 a success indication in the authentication data/security information notify/store acknowledgement message. Otherwise, a failure is sent.

At 1124 (step 6b.), the success or failure indication is further communicated (e.g., transmitted, sent). In one or more implementations, if a successful authentication data/security information notify/store acknowledgement message is received, the CCF-A 1102 sends to the API invoker 1108 a success indication in the authentication data/security information forward acknowledgement message. Otherwise, a failure is sent.

At 1126 (step 7.), an authentication initiation request is communicated (e.g., transmitted, sent). In one or more implementations, if a success indication is received at 1124, the API invoker 1108 sends an authentication initiation request to the AEF 1106, including the CCF assigned API invoker ID.

At 1128 and 1130 (steps 8A and 8B), the AEF 1106 communicates (e.g., transmits, receives) a request for security information and receives a response. In one or more implementations, the AEF 1106 requests for security information from the CCF-B 1104 to perform authentication and secure interface establishment with the API invoker 1108, if the AEF 806 does not have security information (e.g., API invoker's root CA certificate for the AEF 1106 to validate the API invoker's certificate). The CCF-B 1104 provides the security information related to the chosen security method (TLS-PKI) to the AEF 1106 over CAPIF-3 reference point, e.g., API invoker's root CA certificate for the AEF 1106 to validate the API invoker's certificate.

At 1132 (step 9), an authentication indication response is communicated (e.g., transmitted, sent). In one or more implementations, after receiving the relevant security information for the authentication, AEF 1106 sends an authentication initiation response message to the API invoker 1108 to initiate the TLS session establishment procedure.

At 1134 (step 10), mutual authentication is performed. In one or more implementations, the API invoker 1108 and the AEF 1106 perform mutual authentication using certificates and establish TLS session over the CAPIF-2e. Certificate based authentication follows the profiles given in 3GPP TS 33.310, clauses 6.1.3a and 6.1.4a.

After successful establishment of TLS on CAPIF-2e reference point, the AEF 1106 authorizes the API invoker 1108's service API invocation request based on authorization information obtained from CCF as specified in subclause 8.16 of 3GPP TS 23.222.

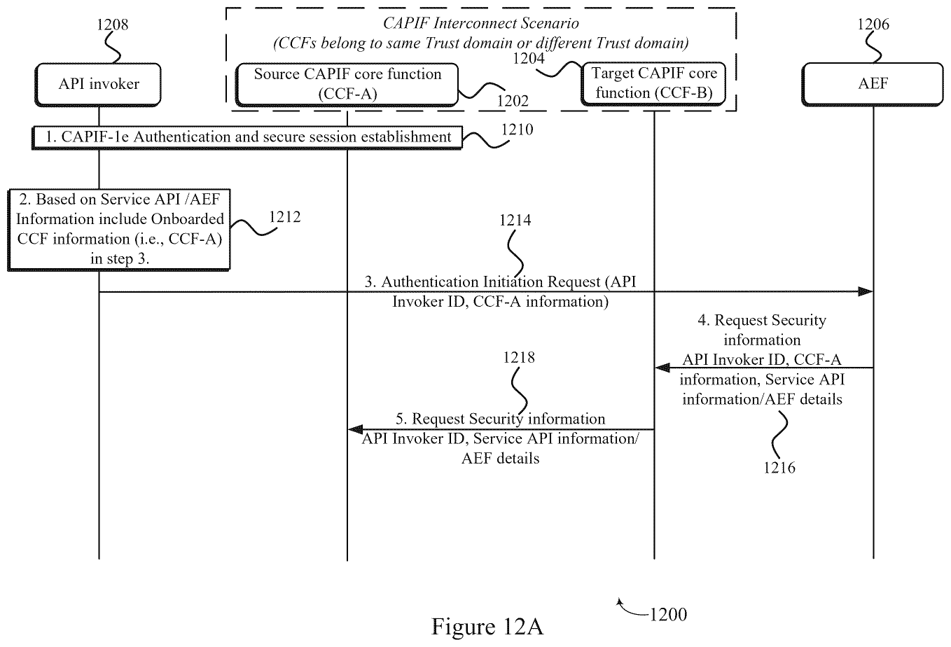

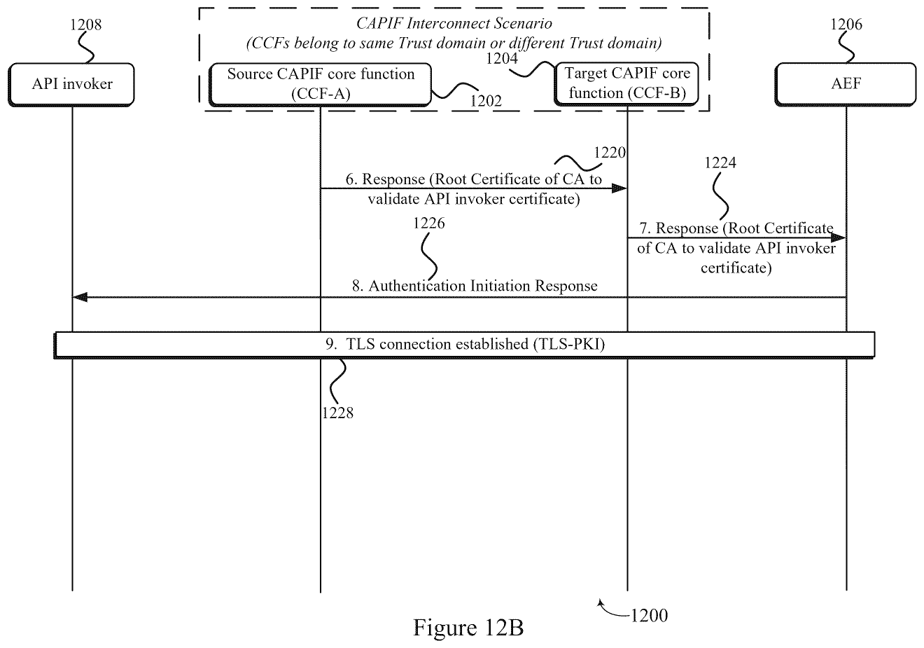

FIGS. 12A and 12B illustrate an example 1200 of authentication and protection in a CAPIF interconnection scenario in accordance with aspects of the present disclosure. The example 1200 illustrates CAPIF-2/2e interface authentication and protection using certificate based mutual authentication in a CAPIF interconnection scenario. The example 1200 illustrates, for TLS-PKI based CAPIF 2/2e authentication and authorization, various aspects to enable security information/authentication and authorization data transfer (e.g., root certificate of CA to validate API invoker's certificate and if needed API invoker's client certificate) between an API invoker onboarded CCF (e.g., a source CCF or CCF-A 1202) and a 3rd party CCF (e.g., a target CCF or CCF-B 1204) which provides the service APIs via an AEF 1206 to an API invoker 1208. The CCF-A 1202 and the CCF-B 1204 can be in a same trust domain or in different trust domains. The example 1200 illustrates the API invoker 1208 includes CCF-A 1202 information (e.g., onboarded CCF ID/address information) in an authentication initiation request based on the service APIs/AEF 1206 being provided by the CCF-B 1204 (as indicated during API invoker 1208 onboarding/security method negotiation) and/or based on security data sharing requirement indication per the AEF 1206 received from the CCF-A 1202 (during security method negotiation) to enable CAPIF 2/2c authentication and authorization between the API invoker 1208 and the AEF 1206 of the CCF-B 1204.

The example 1200 details the message flow between the API invoker 1208, the CCF-A 1202, the CCF-B 1204, and the AEF 1206 related to this security method.

At 1210 (step 1.), a session between the API invoker 1208 and the CCF-A 1202 is established. In one or more implementations, CAPIF-1e authentication and secure session is established between the API invoker 1208 and it's onboarded CCF-A 1202.

At 1212 (step 2.), a check is made as to which CCF the service APIs/AEF belong to. In one or more implementations, the API invoker 1208 checks if the service APIs/AEF 1206 belong to the onboarded CCF (e.g., CCF-A 1202) or belong to any 3rd party CCF (e.g., CCF-B 1204). If the service APIs/AEF 1206 belong to the 3rd party CCF (e.g., CCF-B 1204), the API invoker 1208 determines to include CCF-B ID/address in the authentication initiation request at 1214 (step 3). For example, based on service API/AEF 1206 Information, the API invoker 1208 determines to include onboarded CCF information (e.g., CCF-A 1202) at 1214 (step 3).

It should be noted that the API invoker 1208 includes CCF-A 1202 information (e.g., onboarded CCF ID/address information) in authentication initiation request based on the service APIs/AEF 1206 being provided by the CCF-B 1204 (as indicated during API invoker 1208 onboarding/security method negotiation) and/or based on security data sharing requirement indication per the AEF 1206 received from the CCF-A 1202 (during security method negotiation) to enable CAPIF 2/2c authentication and authorization between the API invoker 1208 and the AEF 1206 of CCF-B 1204.

At 1214 (step 3.), an authentication initiation request is communicated (e.g., transmitted, sent). In one or more implementations, the API invoker 1208 sends an authentication initiation request to the AEF 1206, including the CCF assigned API invoker ID and onboarded CCF Information e.g., CCF-A ID/address.

At 1216 (step 4.), the AEF 1206 communicates (e.g., transmits, sends) a request for security information. In one or more implementations, the AEF 1206 sends the request security information message which includes the API invoker ID, CCF-A ID/address, Service API information (names), AEF 1206 details (IDs) to request for security information from the CCF-B 1204 to perform authentication and secure interface establishment with the API invoker 1208, if the AEF 1206 does not have a valid security information.

At 1218 (step 5.), the CCF-B 904 communicates (e.g., transmits, sends) a request for security information. In one or more implementations, if the CCF-B 1204 finds that it does not have any security information related to the API invoker 1208, the CCF-B 1204 contacts the CCF-A 1202 based on the CCF-A 1202 information (e.g., ID/address). The CCF-B 1204 sends the request security information message to the CCF-A 1202, which includes the API invoker ID, Service API information (names), and AEF 1206 details (IDs) to request for security information from the CCF-B 1204.

At 1220 and 1224 (steps 6 and 7), a response to the request for security information is communicated (e.g., transmitted, received). In one or more implementations, the CCF-A 1202 fetches the security information service API information (names), and AEF 1206 details (IDs) (based on the received service API information (names), and AEF 1206 details (IDs)) and related to the API invoker ID and further provides the security information related to the chosen security method (TLS-PKI) e.g., API invoker's root CA certificate for the AEF 1206 to validate the API invoker's certificate to the CCF-B 1204 in response message over CAPIF-6/6e interface. Further the CCF-B 1204 sends the security information related to the chosen security method (TLS-PKI) e.g., API invoker's root CA certificate for the AEF 1206 to validate the API invoker's certificate in response message to the AEF 1206 over CAPIF-3 reference point.

At 1226 (step 8.), an authentication indication response is communicated (e.g., transmitted, sent). In one or more implementations, after receiving the relevant security information for the authentication, the AEF 1206 sends an authentication initiation response message to the API invoker 1208 to initiate the TLS session establishment procedure.

At 1228 (step 9.), mutual authentication is performed. In one or more implementations, the API invoker 1208 and the AEF 1206 perform mutual authentication using certificates and establish TLS session over the CAPIF-2e. Certificate based authentication follows the profiles given in 3GPP TS 33.310, clauses 6.1.3a and 6.1.4a.

After successful establishment of TLS on CAPIF-2e reference point, the AEF 1206 authorizes the API invoker 1208's service API invocation request based on authorization information obtained from the CCF as specified in subclause 8.16 of 3GPP TS 23.222.

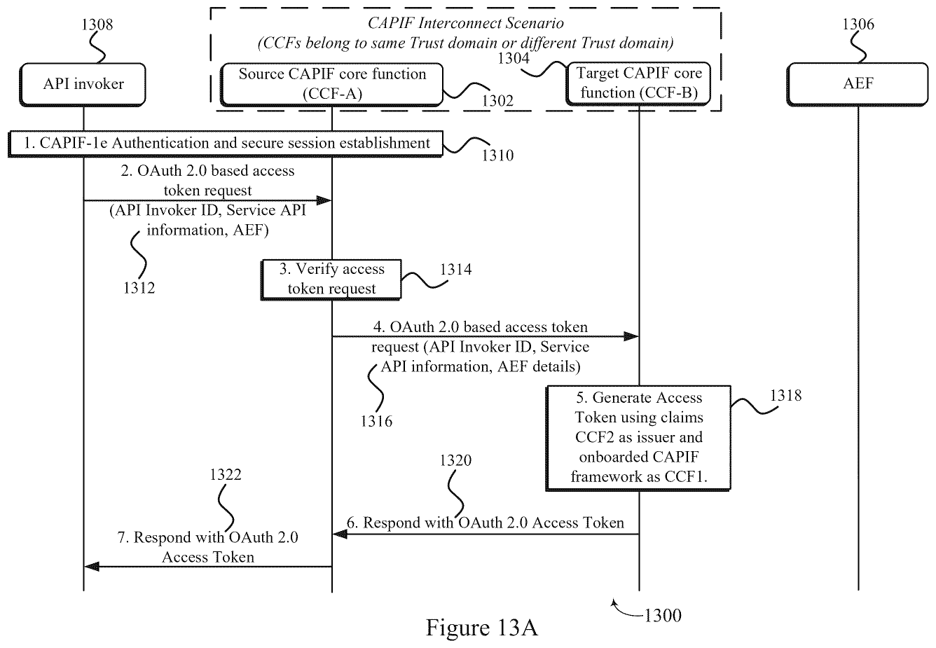

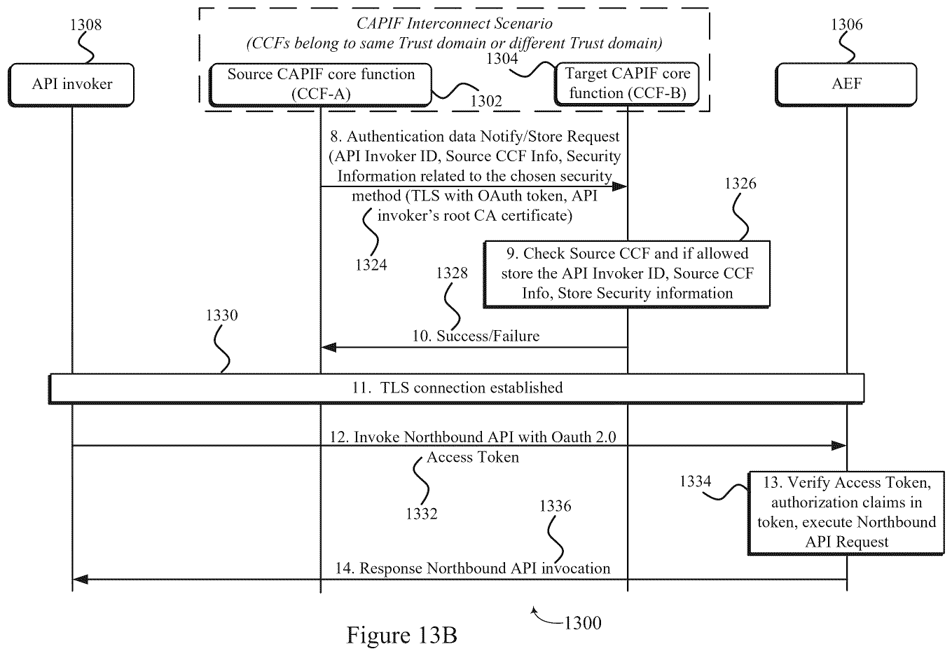

FIGS. 13A and 13B illustrate an example 1300 of authentication and protection in a CAPIF interconnection scenario in accordance with aspects of the present disclosure. The example 1300 illustrates CAPIF-2/2e interface authentication and protection using access tokens in a CAPIF interconnection scenario.

The example 1300 illustrates, for TLS with OAuth Token based CAPIF 2/2c authentication and authorization, various aspects to enable security information/authentication and authorization data transfer (e.g., root certificate of CA to validate API invoker's certificate and if needed API invoker's client certificate from CCF A to CCF-B and if needed OAuth access token from CCF-B to CCF-A) between an API invoker onboarded CCF (e.g., a source CCF or CCF-A 1302) and a 3rd party CCF (e.g., a target CCF or CCF-B 1304) which provides the service APIs via AEF 1306 to an API invoker 1308.

On receiving an OAuth access token request from the API invoker 1308, the CCF-A 1302 requests the access token from the CCF-B 1304 by providing the API invoker ID, service API information and AEF details as necessary for the issue of OAuth access token by the CCF-1304 B for the service APIs provided by the CCF-B 1304.

During OAuth access token request/response or following a successful OAuth access token response being sent to the API invoker 1308, the CCF-A 1302 provides the CCF-B 1304 with the necessary security information to enable CAPIF 2/2e authentication and authorization between the API invoker 1308 and the AEF 1306 of the CCF-B 1304. Additionally, or alternatively, the API invoker 1308 based on service API information includes CCF-A 1302 information in the service API invocation request to let the CCF-B 1304 fetch the necessary security information from the CCF-A 1302 and to provide the security information to the CCF-B's AEF 1306.

It should be noted that the security information can also be referred to as authentication and authorization data.

The example 1300 illustrates establishment of a secure channel over CAPIF-1e, CAPIF-2e reference points, and uses the OAuth 2.0 token-based mechanism to authorize and honor API invoker's northbound API invocations to the 3rd party CCF-B's API exposing function. The example 1300 details security information flows between the API invoker 1308, the CCF-A 1302, the CCF-B 1304, and the CCF-B's AEF 1306. It is assumed that the API invoker 1308, the CCF-A 1302, the CCF-B 1304, and the AEF 1306 are pre-provisioned with the appropriate credentials and related information to establish a secure session.

As per OAuth 2.0, the CCF-A 1302 or the CCF-B 1304 performs the functionality of the authorization server and provides the token endpoint, the API invoker 1308 performs the function of the client functionality, while the AEF 1306 performs the resource server functions. The API invoker 1308 client (client endpoint) can be registered as a confidential client type with an authorization grant type of ‘client credentials’. The authorization is previously arranged in the CCF-A 1302 or the CCF-B. The access token follows the profile described herein. The authorization can be pre-arranged (pre-configured) with the CCF using any of a variety of public or proprietary techniques.

At 1310 (step 1.), a session between the API invoker 1308 and the CCF-A 1302 is established. In one or more implementations, CAPIF-1e authentication and secure session establishment is performed.

At 1312 (step 2.), an access token request is communicated (e.g., transmitted or sent). In one or more implementations, after successful establishment of TLS session over CAPIF-1e, the API invoker 1308 sends an access token request message to the CCF-A 1302 as per the OAuth 2.0 specification which includes the API invoker ID, service API information, and AEF 1306 details.

At 1314 (step 3.), the request is verified. In one or more implementations, the CCF-A 1302 verifies the access token request message per the OAuth 2.0 specification.

At 1316 (step 4.), an access token request is communicated (e.g., transmitted or sent). In one or more implementations, if the CCF-A 1302 successfully verifies the access token request message, if the CCF-A 1302 finds that the service APIs and AEFs listed at 1310 (in step 2) belongs to a different 3rd party CCF-B 1304, then the CCF-A 1302 sends an OAuth Access Token Request message to the CCF-B 1304, where the OAuth Access Token Request message includes the API invoker ID, service API information, and AEF 1306 details.

At 1318 and 1320 (steps 5 and 6), a check is made as to whether the CCF-A 1302 is permitted to access the access token and/or authentication information. In one or more implementations, the CCF-B 1304 checks if the source CCF-A 1302 is allowed to request the access token and/or CAPIF-2/2e authentication and authorization information related to the listed service APIs/AEF 1306 based on the local access policy stored for the CAPIF interconnection. If allowed, the CCF-B 1304 generates an access token specific to the API invoker 1308, issuer as CCF-B address/ID and allowed service APIs related to the AEF 1306 and returns this token in an Access Token Response message. Meanwhile the CCF-B 1304 stores the API invoker ID, Source CCF Info, AEF Information, Service API Information, and chosen security method (TLS with OAuth token).

Steps 1 to 4 (at 1310, 1312, 1314, and 1316) of the example 1300 may be skipped if the API invoker 1308 is already in possession of a valid OAuth access token. In this case, the API invoker 1308 begins the procedure at 1318 (step 5.).

It should be noted that the API invoker 1308 may include the CCF assigned API invoker ID and the Onboard_Secret in the OAuth access token request message for the CCF-A/B to validate the access token request.

At 1322 (step 7.), the access token is sent to the API invoker 1308. In one or more implementations, the CCF-A 1302 sends the received OAuth access token to the API invoker 1308 in the Access Token Response message.

Steps 8-10 (at 1324, 1326, and 1328) of the example 1300 allow the CCF-A 1302 to share the security information. In one or more implementations, steps 8-10 (at 1324, 1326, and 1328) can be performed to let the CCF-A 1302 share the security information related to the chosen security method (TLS with OAuth token) to the CCF-B 1304 for the API invoker ID to let the API invoker 1308 and AEF 1306 perform CAPIF-2/2e authentication and authorization based on the chosen security method (TLS with OAuth token).

At 1324 (step 8.), a security data notify or store request is sent. In one or more implementations, the CCF-A 1302 sends a Security Information/Authentication data Notify/Store request message to the CCF-B 1304, which includes the API invoker ID, Source CCF Info, and Security Information related to the chosen security method (TLS with OAuth token, API invoker's root CA certificate).

At 1326 (step 9.), a check is made as to whether the CCF-A 1302 is permitted to provide the security data notify or store request. In one or more implementations, the CCF-B 1304 checks if the source CCF-A 1302 is allowed to provide the security information/authentication data notify/store request for the API invoker 1308 for the service APIs/AEFs 1306 related to CAPIF-2/2e authentication and authorization based on the local access policy stored for the CAPIF interconnection. If allowed, the CCF-B 1304 stores the received API invoker ID, Source CCF Info, and Security Information related to the chosen security method (TLS with OAuth token, API invoker's root CA certificate).

At 1328 (step 10.), an indication of success or failure is returned. In one or more implementations, following a successful authentication data/security information storage for the API invoker ID, the CCF-B 1304 sends to the CCF-A 1302 a success indication in the Authentication data/Security Information Notify/Store acknowledgement message. Otherwise, a failure is sent.

At 1330 (step 11.), a TLS connection is established. In one or more implementations, on CAPIF-2e, the API invoker 1308 authenticates to the AEF 1306 of CCF-B 1304 by establishing a TLS session with the AEF 1306 based on the authentication and authorization method (e.g., server (AEF 1306) side certificate authentication or certificate-based mutual authentication) as indicated by the CCF. The following procedure is performed prior to establishment of TLS session. The API invoker 1308 sends an Authentication Initiation Request to the AEF 1306, including the API invoker ID. The AEF 1306 requests for security information from the CCF-B 1304 to perform authentication and secure interface establishment with the API invoker 1308. The CCF-B 1304 provides the security information related to the chosen security method (TLS with OAuth token) (stored in step 9 at 1326) to the AEF 1306 over CAPIF-3 reference point. The CCF-B 1304 may return the API invoker's root CA certificate for the AEF 1306 to validate the API invoker's certificate. After fetching the relevant security information for the authentication, the AEF 1306 sends an Authentication Initiation Response message to the API invoker 1308 to initiate the TLS session establishment procedure.

At 1332 (step 12.), the API is invoked. In one or more implementations, with successful authentication to the AEF 1306 on CAPIF-2c, the API invoker 1308 initiates invocation of a 3GPP northbound API with the AEF 1306. The access token received from the CAPIF core is sent along with the northbound API invocation request as per OAuth 2.0.

At 1334 (step 13.), the AEF 1306 validates the access token. In one or more implementations, the AEF 1306 verifies the integrity of the access token by verifying the CCF-B's signature based on the CCF-B ID/address claim. If validation of the access token is successful, the AEF 1306 verifies the API invoker's northbound API invocation request against the authorization claims in the access token, ensuring that the API invoker 1308 has access permission for the requested service API.

At 1336 (step 14.), a response to the invocation request is returned. In one or more implementations, after successful verification of the access token and authorization claims of the API invoker 1308, the requested northbound API is invoked and the appropriate response is returned to the API invoker 1308.

Additionally, or alternatively, the example 1300 can be modified as follows. At 1310 (step 1.), CAPIF-1e authentication and secure session is established between the API invoker 1308 and its onboarded CCF-A 1302. At 1312-1322 (steps 2-7), the API invoker 1308 performs access token request and receives access token as described above). Steps 8 to step 10 (at 1324, 1326, and 1328) need not be preformed.

At 1330 (step 11), for the TLS connection establishment, the API invoker 1308 checks if the service APIs/AEF 1306 belong to the onboarded CCF (e.g., CCF-A 1302) or belong to any 3rd party CCF (e.g., CCF-B 1304). If the service APIs/AEF 1306 belong to the 3rd party CCF (e.g., CCF-B 1304), the API invoker 1308 determines to include the CCF-B ID/address in the Authentication Initiation Request. For example, based on service API/AEF Information, the API invoker 1308 determines to include the onboarded CCF information (e.g., CCF-A 1302).

Additionally, or alternatively, the API invoker 1308 includes CCF-A 1302 information (e.g., onboarded CCF ID/address information) in an Authentication Initiation request based on the service APIs/AEF 1306 being provided by the CCF-B 1304 (as indicated during API invoker 1308 onboarding/security method negotiation) and/or based on security data sharing requirement indication per AEF 1306 received from the CCF-A 1302 (during security method negotiation) to enable CAPIF 2/2e authentication and authorization between the API invoker 1308 and the AEF 1306 of CCF-B 1304.

It should be noted that the API invoker 1308 includes CCF-A 1302 information (e.g., onboarded CCF ID/address information) in an Authentication Initiation request based on the service APIs/AEF 1306 being provided by CCF-B 1304 (as indicated during API invoker 1308 onboarding/security method negotiation) and/or based on security data sharing requirement indication per AEF 1306 received from the CCF-A 1302 (during security method negotiation) to enable CAPIF 2/2e authentication and authorization between the API invoker 1308 and the AEF 1306 of CCF-B 1304.

The API invoker 1308 sends an Authentication Initiation Request to the AEF 1306, including the CCF assigned API invoker ID and onboarded CCF Information e.g., CCF-A ID/address.

The AEF 1306 sends the Request Security Information message which includes the API invoker ID, CCF-A ID/address, Service API information (names), and AEF details (IDs) to request for security information from the CCF-B 1304 to perform authentication and secure interface establishment with the API invoker 1308, if the AEF 1306 does not have a valid security information.

If the CCF-B 1304 finds that it does not have any security information related to the API invoker 1308, the CCF-B 1304 contacts the CCF-A 1302 based on the CCF-A 1302 information (e.g., ID/address). The CCF-B 1304 sends the request security information message to CCF-A 1302, which includes the API invoker ID, Service API information (names), and AEF details (IDs) to request for security information from the CCF-B 1304.

The CCF-A 1302 fetches the security information service API information (names), and AEF details (IDs) (based on the received Service API information (names), and AEF details (IDs)) and related to the API invoker ID and further provides the security information related to the chosen security method (TLS with OAuth token, API invoker's root CA certificate) in a response message over CAPIF-6/6e interface. Further the CCF-B 1304 sends the security information related to the chosen security method (TLS with OAuth token, API invoker's root CA certificate) in response message to the AEF 1306 over CAPIF-3 reference point.

After receiving the relevant security information for the authentication, the AEF 1306 sends an Authentication Initiation Response message to the API invoker 1308 to initiate the TLS session establishment procedure.

At 1332 (step 12.), the API is invoked. In one or more implementations, with successful authentication to the AEF 1306 on CAPIF-2e, the API invoker 1308 shall initiate invocation of a 3GPP northbound API with the AEF 1306. The access token received from the CAPIF core is sent along with the northbound API invocation request as per OAuth 2.0.

At 1334 (step 13.), the AEF 1306 validates the access token. In one or more implementations, the AEF 1306 verifies the integrity of the access token by verifying the CCF-B's signature based on the CCF-B ID/address claim. If validation of the access token is successful, the AEF 1306 verifies the API invoker's Northbound API invocation request against the authorization claims in access token, ensuring that the API invoker 1308 has access permission for the requested service API.

At 1336 (step 14.), a response to the invocation request is returned. In one or more implementations, after successful verification of the access token and authorization claims of the API invoker 1308, the requested northbound API is invoked and the appropriate response is returned to the API invoker 1308.

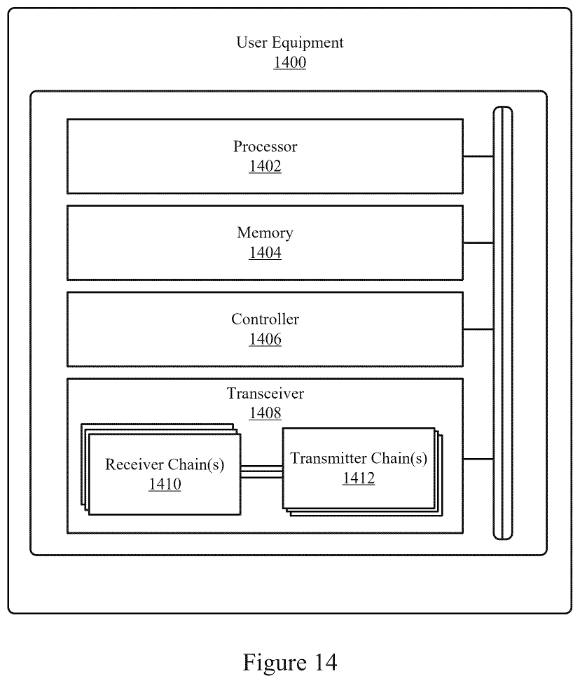

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein. The UE 1400 may be configured to or operable to support a means for receiving a first signaling indicating a first authentication request corresponding to an API invoker, where the first authentication request includes one or more of an API invoker ID of the API invoker, an API invoker URI, an AEF information, or service API information; and transmitting, to a second CCF, a second signaling indicating a second authentication request, where the second authentication request includes one or more of the API invoker ID, the API invoker URI, the AEF information, the service API information, a pre-shared key for the AEF, or a root certificate of a CA to validate a certificate of the API invoker.

Additionally, the UE 1400 may be configured to support any one or combination of where the second authentication request includes an identifier of the first CCF, and the at least one processor is configured to cause the apparatus to receive the first signaling from the API invoker; where the first CCF and the second CCF are located in two different trust domains or in a same trust domain; transmit the second signaling to the second CCF based at least in part on the AEF information or the service API information; where the AEF information includes at least one of an identifier of the AEF or an identifier of the second CCF related to the AEF; derive, prior to receiving the first signaling and based at least in part on an identifier or address of the second CCF, the pre-shared key for the AEF; where the first authentication request includes an authentication data or security information forward request, where the second authentication request includes an additional authentication data or security information notify or store request; receiving, from the second CCF, a third signaling indicating a success or failure indication that indicates whether the first CCF is allowed to perform the additional authentication data or security information notify or store request for the AEF or service API; and transmitting, to the API invoker, a fourth signaling indicating the success or failure indication.

For example, the processor 1402 may support wireless communication at the UE 1400 in accordance with examples as disclosed herein. The UE 1400 may be configured to or operable to support a means for receiving a first signaling indicating a security information request corresponding to an API invoker, where the security information request includes one or more of an API invoker ID of the API invoker, service API information, or AEF information; and transmitting a second signaling indicating a response, where the response includes at least one of a pre-shared key for the AEF, or a root certificate of a CA to validate a certificate of the API invoker.

Additionally, the UE 1400 may be configured to support any one or combination of receiving the first signaling from the AEF; where the first CCF and the second CCF are located in two different trust domains or in a same trust domain; where the AEF information includes at least one of service APIs supported by the AEF, an identifier of the AEF or an identifier of the second CCF; deriving, prior to receiving the first signaling and based at least in part on an identifier or address of the second CCF, the pre-shared key for the AEF.

For example, the processor 1402 may support wireless communication at the UE 1400 in accordance with examples as disclosed herein. The UE 1400 may be configured to or operable to support a means for receiving a first signaling indicating an access token request corresponding to an API invoker, where the access request includes one or more of an API invoker ID of the API invoker, an AEF information, or service API information; and transmitting a second signaling indicating an access token for the API invoker and one or more API services indicated in the service API information.

Additionally, the UE 1400 may be configured to support any one or combination of receiving a third signaling indicating an authentication data notify or store request, where the authentication data notify or store request includes one or more of the API invoker ID, information of a second CCF, security information related to a security method, or a root certificate of a CA of the API invoker; and transmitting a fourth signaling indicating success or failure of the authentication request; where the access token request includes an identifier of a second CCF, where the access token indicates the first CCF is an issuer of the access token, and receiving the first signaling from a second CCF and transmit the second signaling to the second CCF.

For example, the processor 1402 may support wireless communication at the UE 1400 in accordance with examples as disclosed herein. The UE 1400 may be configured to or operable to support a means for generating, based at least in part on a service API, AEF information related to a first CCF, or a security data sharing requirement of the AEF, CCF information for the first CCF; and transmitting a first signaling indicating an authentication request corresponding to the API invoker, where the first signaling includes the CCF information for the first CCF.

Additionally, the UE 1400 may be configured to support any one or combination of where the CCF information includes an ID or address of the first CCF; transmitting the first signaling to the AEF; where the API invoker is onboarded to the first CCF; determining to include the CCF information in the authentication request in response to AEF being provided by a second CCF.

Additionally, or alternatively, the UE 1400 may support at least one memory (e.g., the memory 1404) and at least one processor (e.g., the processor 1402) coupled with the at least one memory and configured to cause the UE to: receive a first signaling indicating a first authentication request corresponding to an API invoker, where the first authentication request includes one or more of an API invoker ID of the API invoker, an API invoker URI, an AEF information, or service API information; and transmit, to a second CCF, a second signaling indicating a second authentication request, where the second authentication request includes one or more of the API invoker ID, the API invoker URI, the AEF information, the service API information, a pre-shared key for the AEF, or a root certificate of a CA to validate a certificate of the API invoker.

Additionally, the UE 1400 may be configured to support any one or combination of where the second authentication request includes an identifier of the first CCF, and the at least one processor is configured to cause the UE to receive the first signaling from the API invoker; where the first CCF and the second CCF are located in two different trust domains or in a same trust domain; where the at least one processor is further configured to cause the UE to transmit the second signaling to the second CCF based at least in part on the AEF information or the service API information; where the AEF information includes at least one of an identifier of the AEF or an identifier of the second CCF related to the AEF; where the at least one processor is further configured to cause the UE to derive, prior to receiving the first signaling and based at least in part on an identifier or address of the second CCF, the pre-shared key for the AEF; where the first authentication request includes an authentication data or security information forward request, where the second authentication request includes an additional authentication data or security information notify or store request, and where the at least one processor is further configured to cause the UE to: receive, from the second CCF, a third signaling indicating a success or failure indication that indicates whether the first CCF is allowed to perform the additional authentication data or security information notify or store request for the AEF or service API; and transmit, to the API invoker, a fourth signaling indicating the success or failure indication.

Additionally, or alternatively, the UE 1400 may support at least one memory (e.g., the memory 1404) and at least one processor (e.g., the processor 1402) coupled with the at least one memory and configured to cause the UE to: receive a first signaling indicating a security information request corresponding to an API invoker, where the security information request includes one or more of an API invoker ID of the API invoker, service API information, or AEF information; and transmit a second signaling indicating a response, where the response includes at least one of a pre-shared key for the AEF, or a root certificate of a CA to validate a certificate of the API invoker.

Additionally, the UE 1400 may be configured to support any one or combination of where the at least one processor is configured to cause the UE to receive the first signaling from the AEF; where the first CCF and the second CCF are located in two different trust domains or in a same trust domain; where the AEF information includes at least one of service APIs supported by the AEF, an identifier of the AEF or an identifier of the second CCF; where the at least one processor is further configured to cause the UE to derive, prior to receiving the first signaling and based at least in part on an identifier or address of the second CCF, the pre-shared key for the AEF.

Additionally, or alternatively, the UE 1400 may support at least one memory (e.g., the memory 1404) and at least one processor (e.g., the processor 1402) coupled with the at least one memory and configured to cause the UE to: receive a first signaling indicating an access token request corresponding to an API invoker, where the access request includes one or more of an API invoker ID of the API invoker, an AEF information, or service API information; and transmit a second signaling indicating an access token for the API invoker and one or more API services indicated in the service API information.

Additionally, the UE 1400 may be configured to support any one or combination of where the at least one processor is configured to cause the UE to: receive a third signaling indicating an authentication data notify or store request, where the authentication data notify or store request includes one or more of the API invoker ID, information of a second CCF, security information related to a security method, or a root certificate of a CA of the API invoker; and transmit a fourth signaling indicating success or failure of the authentication request; where the access token request includes an identifier of a second CCF, where the access token indicates the first CCF is an issuer of the access token, and where the at least one processor is configured to cause the UE to receive the first signaling from a second CCF and transmit the second signaling to the second CCF.

Additionally, or alternatively, the UE 1400 may support at least one memory (e.g., the memory 1404) and at least one processor (e.g., the processor 1402) coupled with the at least one memory and configured to cause the UE to: generate, based at least in part on a service API, AEF information related to a first CCF, or a security data sharing requirement of the AEF, CCF information for the first CCF; and transmit a first signaling indicating an authentication request corresponding to the API invoker, where the first signaling includes the CCF information for the first CCF.

Additionally, the UE 1400 may be configured to support any one or combination of where the CCF information includes an ID or address of the first CCF; where the at least one processor is further configured to cause the UE to transmit the first signaling to the AEF; where the API invoker is onboarded to the first CCF; where the at least one processor is further configured to cause the UE to determine to include the CCF information in the authentication request in response to AEF being provided by a second CCF.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

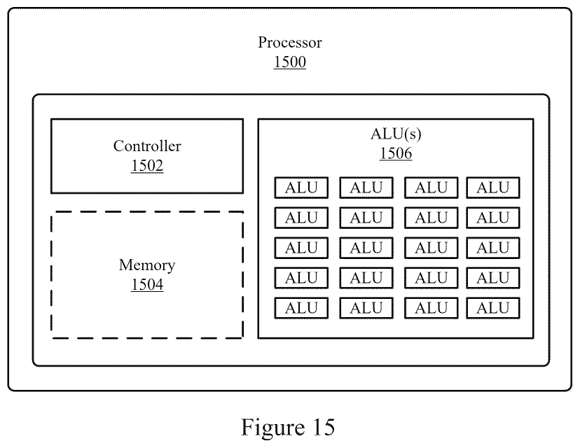

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor to: receive a first signaling indicating a first authentication request corresponding to an API invoker, where the first authentication request includes one or more of an API invoker ID of the API invoker, an API invoker URI, an AEF information, or service API information; and transmit, to a second CCF, a second signaling indicating a second authentication request, where the second authentication request includes one or more of the API invoker ID, the API invoker URI, the AEF information, the service API information, a pre-shared key for the AEF, or a root certificate of a CA to validate a certificate of the API invoker.

Additionally, the processor 1500 may be configured to or operable to support any one or combination of where the second authentication request includes an identifier of the first CCF, and the at least one controller is configured to cause the processor to receive the first signaling from the API invoker; where the first CCF and the second CCF are located in two different trust domains or in a same trust domain; where the at least one processor is further configured to cause the processor to transmit the second signaling to the second CCF based at least in part on the AEF information or the service API information; where the AEF information includes at least one of an identifier of the AEF or an identifier of the second CCF related to the AEF; at least one controller is configured to cause the processor to cause the processor to derive, prior to receiving the first signaling and based at least in part on an identifier or address of the second CCF, the pre-shared key for the AEF; where the first authentication request includes an authentication data or security information forward request, where the second authentication request includes an additional authentication data or security information notify or store request, and where the at least one controller is configured to cause the processor to receive, from the second CCF, a third signaling indicating a success or failure indication that indicates whether the first CCF is allowed to perform the additional authentication data or security information notify or store request for the AEF or service API; and transmit, to the API invoker, a fourth signaling indicating the success or failure indication.

The processor 1500 may be configured to or operable to support at least one controller (e.g., the controller 1502) coupled with at least one memory (e.g., the memory 1504) and configured to cause the processor to: receive a first signaling indicating a security information request corresponding to an API invoker, where the security information request includes one or more of an API invoker ID of the API invoker, service API information, or AEF information; and transmit a second signaling indicating a response, where the response includes at least one of a pre-shared key for the AEF, or a root certificate of a CA to validate a certificate of the API invoker.

Additionally, the processor 1500 may be configured to or operable to support any one or combination of the at least one controller is configured to cause the processor to receive the first signaling from the AEF; where the first CCF and the second CCF are located in two different trust domains or in a same trust domain; where the AEF information includes at least one of service APIs supported by the AEF, an identifier of the AEF or an identifier of the second CCF; the at least one controller is configured to cause the processor to derive, prior to receiving the first signaling and based at least in part on an identifier or address of the second CCF, the pre-shared key for the AEF.

The processor 1500 may be configured to or operable to support at least one controller (e.g., the controller 1502) coupled with at least one memory (e.g., the memory 1504) and configured to cause the processor to: receive a first signaling indicating an access token request corresponding to an API invoker, where the access request includes one or more of an API invoker ID of the API invoker, an AEF information, or service API information; and transmit a second signaling indicating an access token for the API invoker and one or more API services indicated in the service API information.

Additionally, the processor 1500 may be configured to or operable to support any one or combination of the at least one controller is configured to cause the processor to receive a third signaling indicating an authentication data notify or store request, where the authentication data notify or store request includes one or more of the API invoker ID, information of a second CCF, security information related to a security method, or a root certificate of a CA of the API invoker; and transmit a fourth signaling indicating success or failure of the authentication request; where the access token request includes an identifier of a second CCF, where the access token indicates the first CCF is an issuer of the access token, and where the at least one controller is configured to cause the processor to receive the first signaling from a second CCF and transmit the second signaling to the second CCF.

The processor 1500 may be configured to or operable to support at least one controller (e.g., the controller 1502) coupled with at least one memory (e.g., the memory 1504) and configured to cause the processor to: generate, based at least in part on a service API, AEF information related to a first CCF, or a security data sharing requirement of the AEF, CCF information for the first CCF; and transmit a first signaling indicating an authentication request corresponding to the API invoker, where the first signaling includes the CCF information for the first CCF.

Additionally, the processor 1500 may be configured to or operable to support any one or combination of where the CCF information includes an ID or address of the first CCF; where the at least one controller is configured to cause the processor to transmit the first signaling to the AEF; where the API invoker is onboarded to the first CCF; where the at least one controller is configured to cause the processor to determine to include the CCF information in the authentication request in response to AEF being provided by a second CCF.

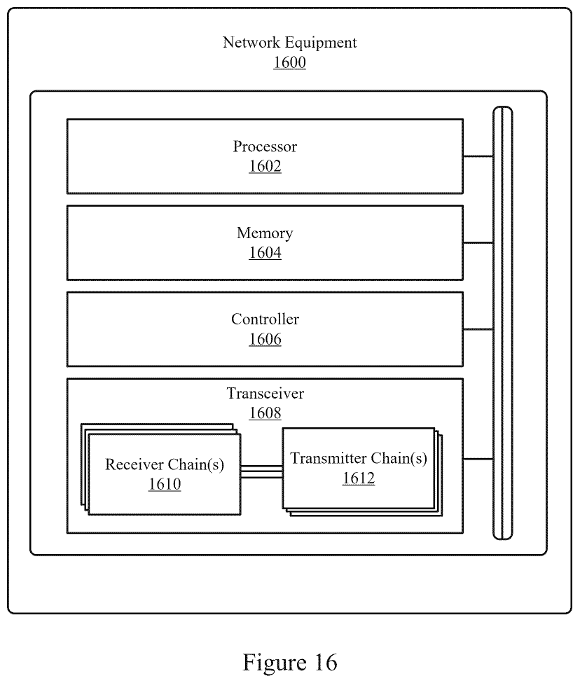

FIG. 16 illustrates an example of a NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein. The NE 1600 may be configured to support a means for receiving a first signaling indicating a first authentication request corresponding to an API invoker, where the first authentication request includes one or more of an API invoker ID of the API invoker, an API invoker URI, an AEF information, or service API information; and transmitting, to a second CCF, a second signaling indicating a second authentication request, where the second authentication request includes one or more of the API invoker ID, the API invoker URI, the AEF information, the service API information, a pre-shared key for the AEF, or a root certificate of a CA to validate a certificate of the API invoker.

Additionally, the NE 1600 may be configured to support any one or combination of where the second authentication request includes an identifier of the first CCF, and the at least one processor is configured to cause the apparatus to receive the first signaling from the API invoker; where the first CCF and the second CCF are located in two different trust domains or in a same trust domain; transmit the second signaling to the second CCF based at least in part on the AEF information or the service API information; where the AEF information includes at least one of an identifier of the AEF or an identifier of the second CCF related to the AEF; derive, prior to receiving the first signaling and based at least in part on an identifier or address of the second CCF, the pre-shared key for the AEF; where the first authentication request includes an authentication data or security information forward request, where the second authentication request includes an additional authentication data or security information notify or store request; receiving, from the second CCF, a third signaling indicating a success or failure indication that indicates whether the first CCF is allowed to perform the additional authentication data or security information notify or store request for the AEF or service API; and transmitting, to the API invoker, a fourth signaling indicating the success or failure indication.

For example, the processor 1602 may support wireless communication at the NE 1600 in accordance with examples as disclosed herein. The NE 1600 may be configured to support a means for receiving a first signaling indicating a security information request corresponding to an API invoker, where the security information request includes one or more of an API invoker ID of the API invoker, service API information, or AEF information; and transmitting a second signaling indicating a response, where the response includes at least one of a pre-shared key for the AEF, or a root certificate of a CA to validate a certificate of the API invoker.

Additionally, the NE 1600 may be configured to support any one or combination of receiving the first signaling from the AEF; where the first CCF and the second CCF are located in two different trust domains or in a same trust domain; where the AEF information includes at least one of service APIs supported by the AEF, an identifier of the AEF or an identifier of the second CCF; deriving, prior to receiving the first signaling and based at least in part on an identifier or address of the second CCF, the pre-shared key for the AEF.

For example, the processor 1602 may support wireless communication at the NE 1600 in accordance with examples as disclosed herein. The NE 1600 may be configured to support a means for receiving a first signaling indicating an access token request corresponding to an API invoker, where the access request includes one or more of an API invoker ID of the API invoker, an AEF information, or service API information; and transmitting a second signaling indicating an access token for the API invoker and one or more API services indicated in the service API information.

Additionally, the NE 1600 may be configured to support any one or combination of receiving a third signaling indicating an authentication data notify or store request, where the authentication data notify or store request includes one or more of the API invoker ID, information of a second CCF, security information related to a security method, or a root certificate of a CA of the API invoker; and transmitting a fourth signaling indicating success or failure of the authentication request; where the access token request includes an identifier of a second CCF, where the access token indicates the first CCF is an issuer of the access token, and receiving the first signaling from a second CCF and transmit the second signaling to the second CCF.

For example, the processor 1602 may support wireless communication at the NE 1600 in accordance with examples as disclosed herein. The NE 1600 may be configured to support a means for generating, based at least in part on a service API, AEF information related to a first CCF, or a security data sharing requirement of the AEF, CCF information for the first CCF; and transmitting a first signaling indicating an authentication request corresponding to the API invoker, where the first signaling includes the CCF information for the first CCF.

Additionally, the NE 1600 may be configured to support any one or combination of where the CCF information includes an ID or address of the first CCF; transmitting the first signaling to the AEF; where the API invoker is onboarded to the first CCF; determining to include the CCF information in the authentication request in response to AEF being provided by a second CCF.

Additionally, or alternatively, the NE 1600 may support at least one memory (e.g., the memory 1604) and at least one processor (e.g., the processor 1602) coupled with the at least one memory and configured to cause the NE to: receive a first signaling indicating a first authentication request corresponding to an API invoker, where the first authentication request includes one or more of an API invoker ID of the API invoker, an API invoker URI, an AEF information, or service API information; and transmit, to a second CCF, a second signaling indicating a second authentication request, where the second authentication request includes one or more of the API invoker ID, the API invoker URI, the AEF information, the service API information, a pre-shared key for the AEF, or a root certificate of a CA to validate a certificate of the API invoker.

Additionally, the NE 1600 may be configured to support any one or combination of where the second authentication request includes an identifier of the first CCF, and the at least one processor is configured to cause the NE to receive the first signaling from the API invoker; where the first CCF and the second CCF are located in two different trust domains or in a same trust domain; where the at least one processor is further configured to cause the NE to transmit the second signaling to the second CCF based at least in part on the AEF information or the service API information; where the AEF information includes at least one of an identifier of the AEF or an identifier of the second CCF related to the AEF; where the at least one processor is further configured to cause the NE to derive, prior to receiving the first signaling and based at least in part on an identifier or address of the second CCF, the pre-shared key for the AEF; where the first authentication request includes an authentication data or security information forward request, where the second authentication request includes an additional authentication data or security information notify or store request, and where the at least one processor is further configured to cause the NE to: receive, from the second CCF, a third signaling indicating a success or failure indication that indicates whether the first CCF is allowed to perform the additional authentication data or security information notify or store request for the AEF or service API; and transmit, to the API invoker, a fourth signaling indicating the success or failure indication.

Additionally, or alternatively, the NE 1600 may support at least one memory (e.g., the memory 1604) and at least one processor (e.g., the processor 1602) coupled with the at least one memory and configured to cause the NE to: receive a first signaling indicating a security information request corresponding to an API invoker, where the security information request includes one or more of an API invoker ID of the API invoker, service API information, or AEF information; and transmit a second signaling indicating a response, where the response includes at least one of a pre-shared key for the AEF, or a root certificate of a CA to validate a certificate of the API invoker.

Additionally, the NE 1600 may be configured to support any one or combination of where the at least one processor is configured to cause the NE to receive the first signaling from the AEF; where the first CCF and the second CCF are located in two different trust domains or in a same trust domain; where the AEF information includes at least one of service APIs supported by the AEF, an identifier of the AEF or an identifier of the second CCF; where the at least one processor is further configured to cause the NE to derive, prior to receiving the first signaling and based at least in part on an identifier or address of the second CCF, the pre-shared key for the AEF.

Additionally, or alternatively, the NE 1600 may support at least one memory (e.g., the memory 1604) and at least one processor (e.g., the processor 1602) coupled with the at least one memory and configured to cause the NE to: receive a first signaling indicating an access token request corresponding to an API invoker, where the access request includes one or more of an API invoker ID of the API invoker, an AEF information, or service API information; and transmit a second signaling indicating an access token for the API invoker and one or more API services indicated in the service API information.

Additionally, the NE 1600 may be configured to support any one or combination of where the at least one processor is configured to cause the NE to: receive a third signaling indicating an authentication data notify or store request, where the authentication data notify or store request includes one or more of the API invoker ID, information of a second CCF, security information related to a security method, or a root certificate of a CA of the API invoker; and transmit a fourth signaling indicating success or failure of the authentication request; where the access token request includes an identifier of a second CCF, where the access token indicates the first CCF is an issuer of the access token, and where the at least one processor is configured to cause the NE to receive the first signaling from a second CCF and transmit the second signaling to the second CCF.

Additionally, or alternatively, the NE 1600 may support at least one memory (e.g., the memory 1604) and at least one processor (e.g., the processor 1602) coupled with the at least one memory and configured to cause the NE to: generate, based at least in part on a service API, AEF information related to a first CCF, or a security data sharing requirement of the AEF, CCF information for the first CCF; and transmit a first signaling indicating an authentication request corresponding to the API invoker, where the first signaling includes the CCF information for the first CCF.

Additionally, the NE 1600 may be configured to support any one or combination of where the CCF information includes an ID or address of the first CCF; where the at least one processor is further configured to cause the NE to transmit the first signaling to the AEF; where the API invoker is onboarded to the first CCF; where the at least one processor is further configured to cause the NE to determine to include the CCF information in the authentication request in response to AEF being provided by a second CCF.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

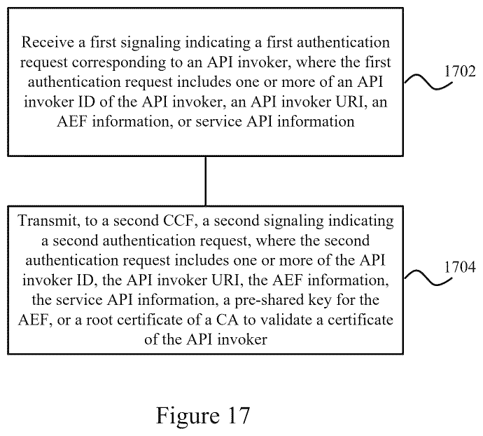

FIG. 17 illustrates a flowchart of a method in accordance with aspects of the present disclosure. The operations of the method may be implemented by a UE as described herein. In some implementations, the UE may execute a set of instructions to control the function elements of the UE to perform the described functions. Additionally, or alternatively, the operations of the method may be implemented by a NE as described herein. In some implementations, the NE may execute a set of instructions to control the function elements of the NE to perform the described functions.

At 1702, the method may include receiving a first signaling indicating a first authentication request corresponding to an API invoker, where the first authentication request includes one or more of an API invoker ID of the API invoker, an API invoker URI, an AEF information, or service API information. The operations of 1702 may be performed in accordance with examples as described herein. In some implementations, aspects of the operations of 1702 may be performed by a UE as described with reference to FIG. 14 or a NE as described with reference to FIG. 16.

At 1704, the method may include transmitting, to a second CCF, a second signaling indicating a second authentication request, where the second authentication request includes one or more of the API invoker ID, the API invoker URI, the AEF information, the service API information, a pre-shared key for the AEF, or a root certificate of a CA to validate a certificate of the API invoker. The operations of 1704 may be performed in accordance with examples as described herein. In some implementations, aspects of the operations of 1704 may be performed by a UE as described with reference to FIG. 14 or a NE as described with reference to FIG. 16.

It should be noted that the method described herein describes a possible implementation, and that the operations and the steps may be rearranged or otherwise modified and that other implementations are possible.

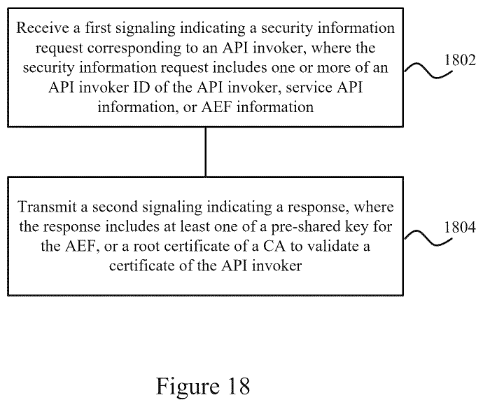

FIG. 18 illustrates a flowchart of a method in accordance with aspects of the present disclosure. The operations of the method may be implemented by a UE as described herein. In some implementations, the UE may execute a set of instructions to control the function elements of the UE to perform the described functions. Additionally, or alternatively, the operations of the method may be implemented by a NE as described herein. In some implementations, the NE may execute a set of instructions to control the function elements of the NE to perform the described functions.

At 1802, the method may include receiving a first signaling indicating a security information request corresponding to an API invoker, where the security information request includes one or more of an API invoker ID of the API invoker, service API information, or AEF information. The operations of 1802 may be performed in accordance with examples as described herein. In some implementations, aspects of the operations of 1802 may be performed by a UE as described with reference to FIG. 14 or a NE as described with reference to FIG. 16.

At 1804, the method may include transmit a second signaling indicating a response, where the response includes at least one of a pre-shared key for the AEF, or a root certificate of a CA to validate a certificate of the API invoker. The operations of 1804 may be performed in accordance with examples as described herein. In some implementations, aspects of the operations of 1804 may be performed by a UE as described with reference to FIG. 14 or a NE as described with reference to FIG. 16.

It should be noted that the method described herein describes a possible implementation, and that the operations and the steps may be rearranged or otherwise modified and that other implementations are possible.

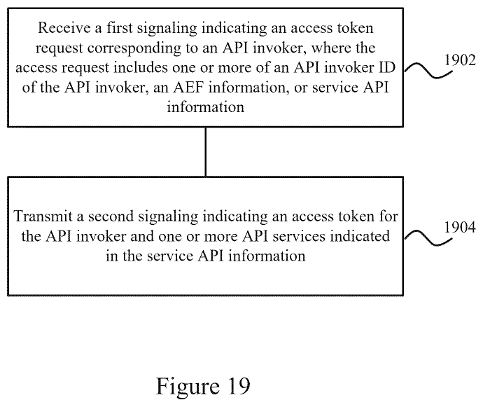

FIG. 19 illustrates a flowchart of a method in accordance with aspects of the present disclosure. The operations of the method may be implemented by a UE as described herein. In some implementations, the UE may execute a set of instructions to control the function elements of the UE to perform the described functions. Additionally, or alternatively, the operations of the method may be implemented by a NE as described herein. In some implementations, the NE may execute a set of instructions to control the function elements of the NE to perform the described functions.

At 1902, the method may include receiving a first signaling indicating an access token request corresponding to an API invoker, where the access request includes one or more of an API invoker ID of the API invoker, an AEF information, or service API information. The operations of 1902 may be performed in accordance with examples as described herein. In some implementations, aspects of the operations of 1902 may be performed by a UE as described with reference to FIG. 14 or a NE as described with reference to FIG. 16.

At 1904, the method may include transmitting a second signaling indicating an access token for the API invoker and one or more API services indicated in the service API information. The operations of 1904 may be performed in accordance with examples as described herein. In some implementations, aspects of the operations of 1904 may be performed by a UE as described with reference to FIG. 14 or a NE as described with reference to FIG. 16.

It should be noted that the method described herein describes a possible implementation, and that the operations and the steps may be rearranged or otherwise modified and that other implementations are possible.

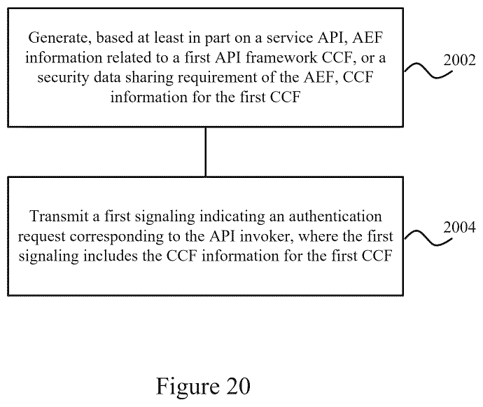

FIG. 20 illustrates a flowchart of a method in accordance with aspects of the present disclosure. The operations of the method may be implemented by a UE as described herein. In some implementations, the UE may execute a set of instructions to control the function elements of the UE to perform the described functions. Additionally, or alternatively, the operations of the method may be implemented by a NE as described herein. In some implementations, the NE may execute a set of instructions to control the function elements of the NE to perform the described functions.

At 2002, the method may include generating, based at least in part on a service API, AEF information related to a first API framework CCF, or a security data sharing requirement of the AEF, CCF information for the first CCF. The operations of 2002 may be performed in accordance with examples as described herein. In some implementations, aspects of the operations of 2002 may be performed by a UE as described with reference to FIG. 14 or a NE as described with reference to FIG. 16.

At 2004, the method may include transmitting a first signaling indicating an authentication request corresponding to the API invoker, where the first signaling includes the CCF information for the first CCF. The operations of 2004 may be performed in accordance with examples as described herein. In some implementations, aspects of the operations of 2004 may be performed by a UE as described with reference to FIG. 14 or a NE as described with reference to FIG. 16.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication that implements a first common application programming interface (API) framework (CAPIF) core function (CCF), the apparatus comprising:
at least one memory; and
at least one processor coupled with the at least one memory and configured to cause the apparatus to:
receive a first signaling indicating a first authentication request corresponding to an API invoker, wherein the first authentication request includes one or more of an API invoker identifier (ID) of the API invoker, an API invoker uniform resource indicator (URI), an API exposing function (AEF) information, or service API information; and
transmit, to a second CCF, a second signaling indicating a second authentication request, wherein the second authentication request includes one or more of the API invoker ID, the API invoker URI, the AEF information, the service API information, a pre-shared key for the AEF, or a root certificate of a certifying authority (CA) to validate a certificate of the API invoker.

2. The apparatus of claim 1, wherein the second authentication request includes an identifier of the first CCF, and the at least one processor is configured to cause the apparatus to receive the first signaling from the API invoker.

3. The apparatus of claim 2, wherein the first CCF and the second CCF are located in two different trust domains or in a same trust domain.

4. The apparatus of claim 2, wherein the at least one processor is further configured to cause the apparatus to transmit the second signaling to the second CCF based at least in part on the AEF information or the service API information.

5. The apparatus of claim 2, wherein the AEF information includes at least one of an identifier of the AEF or an identifier of the second CCF related to the AEF.

6. The apparatus of claim 2, wherein the at least one processor is further configured to cause the apparatus to derive, prior to receiving the first signaling and based at least in part on an identifier or address of the second CCF, the pre-shared key for the AEF.

7. The apparatus of claim 2, wherein the first authentication request comprises an authentication data or security information forward request, wherein the second authentication request comprises an additional authentication data or security information notify or store request, and wherein the at least one processor is further configured to cause the apparatus to:
receive, from the second CCF, a third signaling indicating a success or failure indication that indicates whether the first CCF is allowed to perform the additional authentication data or security information notify or store request for the AEF or service API; and
transmit, to the API invoker, a fourth signaling indicating the success or failure indication.

8. An apparatus for wireless communication that implements a first common application programming interface (API) framework (CAPIF) core function (CCF), the apparatus comprising:
at least one memory; and
at least one processor coupled with the at least one memory and configured to cause the apparatus to:
receive a first signaling indicating a security information request corresponding to an application programming interface (API) invoker, wherein the security information request includes one or more of an API invoker identifier (ID) of the API invoker, service API information, or API exposing function (AEF) information; and
transmit a second signaling indicating a response, wherein the response includes at least one of a pre-shared key for the AEF, or a root certificate of a certifying authority (CA) to validate a certificate of the API invoker.

9. The apparatus of claim 8, wherein the at least one processor is configured to cause the apparatus to receive the first signaling from the AEF.

10. The apparatus of claim 9, wherein the first CCF and the second CCF are located in two different trust domains or in a same trust domain.

11. The apparatus of claim 9, wherein the AEF information includes at least one of service APIs supported by the AEF, an identifier of the AEF or an identifier of the second CCF.

12. The apparatus of claim 9, wherein the at least one processor is further configured to cause the apparatus to derive, prior to receiving the first signaling and based at least in part on an identifier or address of the second CCF, the pre-shared key for the AEF.

13. An apparatus for wireless communication that implements a first common application programming interface (API) framework (CAPIF) core function (CCF), the apparatus comprising:
at least one memory; and
at least one processor coupled with the at least one memory and configured to cause the apparatus to:
receive a first signaling indicating an access token request corresponding to an application programming interface (API) invoker, wherein the access request includes one or more of an API invoker identifier (ID) of the API invoker, an API exposing function (AEF) information, or service API information; and
transmit a second signaling indicating an access token for the API invoker and one or more API services indicated in the service API information.

14. The apparatus of claim 13, wherein the at least one processor is configured to cause the apparatus to:
receive a third signaling indicating an authentication data notify or store request, wherein the authentication data notify or store request includes one or more of the API invoker ID, information of a second CCF, security information related to a security method, or a root certificate of a certifying authority (CA) of the API invoker; and
transmit a fourth signaling indicating success or failure of the authentication request.

15. The apparatus of claim 13, wherein the access token request includes an identifier of a second CCF, wherein the access token indicates the first CCF is an issuer of the access token, and wherein the at least one processor is configured to cause the apparatus to receive the first signaling from a second CCF and transmit the second signaling to the second CCF.

16. An apparatus for wireless communication that implements an application programming interface (API) invoker, the apparatus comprising:
at least one memory; and
at least one processor coupled with the at least one memory and configured to cause the apparatus to:
generate, based at least in part on a service application programming interface (API), API exposing function (AEF) information related to a first common API framework (CAPIF) core function (CCF), or a security data sharing requirement of the AEF, CCF information for the first CCF; and
transmit a first signaling indicating an authentication request corresponding to the API invoker, wherein the first signaling includes the CCF information for the first CCF.

17. The apparatus of claim 16, wherein the CCF information includes an identifier (ID) or address of the first CCF.

18. The apparatus of claim 16, wherein the at least one processor is further configured to cause the apparatus to transmit the first signaling to the AEF.

19. The apparatus of claim 16, wherein the API invoker is onboarded to the first CCF.

20. The apparatus of claim 16, wherein the at least one processor is further configured to cause the apparatus to determine to include the CCF information in the authentication request in response to AEF being provided by a second CCF.
